(19) United States
(12) Patent Application Publication
(10) Pub. No.: US 2025/0392969 A1
(43) Pub. Date: Dec. 25, 2025

(54) METHODS AND APPARATUSES OF ENHANCEMENTS FOR AN INTER-RAT HO PROCEDURE

(71) Applicant: LENOVO (BEIJING) LIMITED, Beijing (CN)

(72) Inventors: Le YAN, Shanghai (CN); Mingzeng DAI, Shanghai (CN); Lianhai WU, Beijing (CN); Congchi ZHANG, Shanghai (CN); Yibin ZHUO, Shanghai (CN)

(21) Appl. No.: 18/879,167

(22) PCT Filed: Jun. 27, 2022
(86) PCT No.: PCT/CN2022/101447

§ 371 Date: Dec. 26, 2024

(51) Int. Cl. H04W 36/00

(52) U.S. Cl. CPC H04W 36/0058; H04W 36/0072

(57) ABSTRACT

Embodiments of the subject application relate to methods and apparatuses of enhancements for an inter-radio access technology (RAT) handover (HO) procedure. According to an embodiment of the subject application, a user equipment (UE) includes a processor and a transceiver coupled to the processor; and the processor is configured to: receive a configuration regarding information associated with a successful completion of an inter-RAT HO procedure, wherein the configuration is related to at least one trigger condition for the UE storing the information; and generate at least one report including the information in response to fulfillment of the at least one trigger condition.

### TECHNICAL FIELD

Embodiments of the present application generally relate to wireless communication technology, in particular to methods and apparatuses of enhancements for an inter-radio access technology (RAT) handover (HO) procedure.

### BACKGROUND

A base station (BS) can have some cells (or areas) to provide communication service. When a user equipment (UE) moves from a serving cell of a source BS to a target cell of a target BS, a handover procedure is performed. When a radio link failure (RLF) or a handover (HO) failure occurs for a UE, the UE may perform a radio resource control (RRC) re-establishment procedure. The UE may access a cell by a successful RRC re-establishment procedure. If RRC re-establishment procedure fails, the UE may perform a radio resource control (RRC) setup procedure. The UE may access a cell by a successful RRC setup procedure. The accessed network will request UE information including a RLF report of the UE, such that the network can optimize the mobility problem based on the UE information from the UE. Accordingly, the UE will transmit a failure report, e.g., a RLF report, to the network.

3rd Generation Partnership Project (3GPP) 5G networks are expected to increase network throughput, coverage, and robustness and reduce latency and power consumption. With the development of 3GPP 5G networks, various aspects need to be studied and developed to perfect the 5G technology. Details regarding mobility robustness optimization (MRO) enhancements for an inter-RAT HO procedure have not been discussed in 3GPP 5G technology yet.

### SUMMARY

Some embodiments of the present application provide a user equipment (UE). The UE includes a transceiver and a processor coupled to the transceiver; and the processor is configured to: receive a configuration regarding first information associated with a successful completion of an inter-radio access technology (RAT) handover (HO) procedure, wherein the configuration is related to at least one trigger condition for the UE storing the first information; and generate at least one report including the first information in response to fulfillment of the at least one trigger condition.

In some embodiments, the processor of the UE is configured to transmit an indication for indicating an optional capability of the UE for storing the first information via the transceiver.

In some embodiments, the configuration is generated by at least one of a source network node or a target network node.

In some embodiments, in response to the configuration generated by the source network node, the at least one trigger condition includes: a ratio between a value of elapsed running time of timer T310 and a configured value of the timer T310 is greater than a first threshold generated by the source network node; or a ratio between a value of elapsed running time of the timer T312 associated with a target cell and a configured value of the timer T312 is greater than a second threshold generated by the source network node.

In some embodiments, in response to the configuration generated by the target network node, the at least one trigger condition includes: a ratio between a value of elapsed running time of the timer T304 and a configured value of the timer T304 is greater than a third threshold generated by the target network node.

In some embodiments, the configuration includes at least one of: the first threshold; the second threshold; or the third threshold.

In some embodiments, the at least one trigger condition includes two or more trigger conditions, and wherein, to generate the at least one report, in response to fulfillment of the two or more trigger conditions, the processor of the UE is configured to: generate two or more reports including the first information; or generate only one report including the first information.

In some embodiments, each report within the at least one report or the first information includes at least one of: information associated with a source cell of a source network node; information associated with a target cell of a target network node; a cell radio network temporary identifier (C-RNTI) of the source cell; a C-RNTI of the target cell; at least one cause associated with the at least one trigger condition; or information associated with a radio access (RA) operation of the UE.

In some embodiments, the information associated with the source cell includes at least one of: cell information associated with the source cell, or one or more measurements results of the source cell. The information associated with the target cell includes at least one of: cell information associated with the target cell, or one or more measurements results of the target cell.

In some embodiments, one report within the two or more reports is associated with one trigger condition within the two or more trigger conditions.

In some embodiments, the processor of the UE is configured to encode the one report or the first information within the one report based on a RAT type of a network node which generates the one trigger condition for the UE storing the first information within the one report.

In some embodiments, the one report or the first information within the one report is encoded in: a RAT format of a source network node; or a RAT format of a target network node.

In some embodiments, the processor of the UE is configured to: generate second information associated with a cell of a first network node, wherein the first network node generates the one trigger condition for the UE storing the first information within the one report, and wherein the second information includes at least one of: a public land mobile network (PLMN) identity (ID), a cell ID, a tracking area code, a physical cell identifier (PCI), or an absolute radio frequency channel number (ARFCN); and transmit the one report and the second information via the transceiver to a network node connected with the UE after completing the inter-RAT HO procedure.

In some embodiments, the processor of the UE is configured to encode the second information in a RAT format of the network node connected with the UE.

In some embodiments, the processor of the UE is configured to encode the only one report or the first information included in the only one report based on a RAT type of a target network node.

In some embodiments, the processor of the UE is configured to: generate cell information associated with a target cell of the target network node; and transmit the only one report and the cell information via the transceiver to a network node connected with the UE after completing the inter-RAT HO procedure, wherein the cell information includes at least one of: a public land mobile network (PLMN) identity (ID), a cell ID, a tracking area code, a physical cell identifier (PCI), or an absolute radio frequency channel number (ARFCN).

In some embodiments, the processor of the UE is configured to encode the cell information in a RAT format of the network node connected with the UE.

In some embodiments, the processor of the UE is configured to encode the only one report or the first information included in the only one report based on a RAT type of a source network node.

In some embodiments, the processor of the UE is configured to: generate cell information associated with a source cell of the source network node, wherein the cell information includes at least one of: a public land mobile network (PLMN) identity (ID), a cell ID, a tracking area code, a physical cell identifier (PCI), or an absolute radio frequency channel number (ARFCN); and transmit the only one report and the cell information via the transceiver to a network node connected with the UE after completing the inter-RAT HO procedure.

In some embodiments, the processor of the UE is configured to encode the cell information in a RAT format of the network node connected with the UE.

In some embodiments, at least one of the RAT format of the source network node, the RAT format of the target network node, or the RAT format of the network node connected with the UE is one of: a format of an universal terrestrial radio access network (UTRAN); a format of an evolved UTRAN (E-UTRAN); a format of new radio (NR); and a format of a next generation.

In some embodiments, the processor of the UE is configured to: transmit an indication for indicating generation of the at least one report via the transceiver to a network node connected with the UE after completing the inter-RAT HO procedure; receive a request for the at least one report or the first information via the transceiver from the network node; and transmit the at least one report via the transceiver to the network node.

Some embodiments of the present application provide a source network node (e.g., a source BS). The source network node includes a transceiver and a processor coupled to the transceiver; and the processor is configured to: generate a first configuration regarding first information associated with a successful completion of an inter-radio access technology (RAT) handover (HO) procedure of a user equipment (UE), wherein the first configuration is related to at least one trigger condition for the UE storing the first information; and transmit the first configuration via the transceiver to the UE.

In some embodiments, the first configuration includes at least one of: a first threshold associated with timer T310; or a second threshold associated with timer T312.

In some embodiments, the processor of the source network node is configured to: receive a second configuration regarding the first information via the transceiver from a target network node, wherein the second configuration includes a third threshold associated with timer T304; and transmit the second configuration via the transceiver to the UE.

In some embodiments, the at least one trigger condition includes one of: a ratio between a value of elapsed running time of timer T310 and a configured value of the timer T310 is greater than the first threshold; a ratio between a value of elapsed running time of the timer T312 associated with a target cell and a configured value of the timer T312 is greater than the second threshold; and a ratio between a value of elapsed running time of the timer T304 and a configured value of the timer T304 is greater than the third threshold.

In some embodiments, the first configuration and the second configuration are transmitted in one message or two messages.

In some embodiments, the processor of the source network node is configured to receive an indication for indicating an optional capability of the UE for storing the first information via the transceiver from the UE.

In some embodiments, at least one of the first configuration or the second configuration is included in a handover command for the inter-RAT HO procedure.

In some embodiments, the processor of the source network node is configured to receive a first report including the first information via the transceiver from: a network node connected with the UE after completing the inter-RAT HO procedure; or a target network node.

In some embodiments, the first report or the first information includes at least one of: information associated with a source cell of the source network node; information associated with a target cell of the target network node; a cell radio network temporary identifier (C-RNTI) of the source cell; a C-RNTI of the target cell; at least one cause associated with the at least one trigger condition; or information associated with a radio access (RA) operation of the UE.

In some embodiments, the information associated with the source cell includes at least one of: cell information associated with the source cell, or one or more measurements results of the source cell. The information associated with the target cell includes at least one of: cell information associated with the target cell, or one or more measurements results of the target cell.

In some embodiments, the first report or the first information in the first report is encoded in a RAT format of the source network node, and the first report or the first information is encoded by: the UE; or the target network node.

In some embodiments, the first report is generated in response to fulfillment of a trigger condition related to the second configuration, the processor of the source network node is configured to transmit a first message via the transceiver to a target network node, and the first message indicates that the first report is generated in response to the fulfillment of the trigger condition related to the second configuration.

In some embodiments, the first message includes at least one of: at least one cause associated with the trigger condition related to the second configuration; or an indication for indicating the fulfillment of the trigger condition related to the second configuration.

In some embodiments, in response to receiving the first report, the processor of the source network node is configured to: encode the first information in a RAT format of the target network node; and transmit a second report including the encoded first information in the RAT format of the target network node via the transceiver to the target network node.

In some embodiments, at least one of the RAT format of the source network node or the RAT format of the target network node is one of: a format of a universal terrestrial radio access network (UTRAN); a format of an evolved UTRAN (E-UTRAN); a format of new radio (NR); and a format of a next generation.

In some embodiments, the processor of the source network node is configured to receive a second message via the transceiver from a target network node, and wherein the second message indicates that the first information is stored in response to fulfillment of a trigger condition related to the first configuration.

In some embodiments, the second message includes at least one of: at least one cause associated with the trigger condition related to the first configuration; or an indication for indicating the fulfillment of the trigger condition related to the first configuration.

In some embodiments, the processor of the source network node is configured to perform a mobility robustness optimization (MRO) analysis and optimization operation for parameters related to the inter-RAT HO procedure.

Some embodiments of the present application provide a target network node. The target network node includes a transceiver and a processor coupled to the transceiver; and the processor is configured to: generate a second configuration regarding first information associated with a successful completion of an inter-radio access technology (RAT) handover (HO) procedure of a user equipment (UE), wherein the second configuration is related to at least one trigger condition for the UE storing the first information; and transmit the second configuration via the transceiver to a source network node.

In some embodiments, the second configuration includes a third threshold associated with timer T304.

In some embodiments, the at least one trigger condition includes one of: a ratio between a value of elapsed running time of timer T310 and a configured value of the timer T310 is greater than a first threshold generated by the source network node; a ratio between a value of elapsed running time of the timer T312 associated with a target cell and a configured value of the timer T312 is greater than a second threshold generated by the source network node; and a ratio between a value of elapsed running time of the timer T304 and a configured value of the timer T304 is greater than the third threshold.

In some embodiments, the processor of the target network node is configured to receive an indication for indicating an optional capability of the UE for storing the first information via the transceiver from the source network node.

In some embodiments, the processor of the target network node is configured to receive a first message via the transceiver from the source network node, and the first message indicates that the first information is stored in response to fulfillment of a trigger condition related to the second configuration.

In some embodiments, the first message includes at least one of: at least one cause associated with the trigger condition related to the second configuration; or an indication for indicating the fulfillment of the trigger condition related to the second configuration.

In some embodiments, the processor of the target network node is configured to: receive an indication for indicating generation of at least one report including the first information via the transceiver from the UE; and transmit a request for the at least one report or the first information via the transceiver to the UE.

In some embodiments, the processor of the target network node is configured to receive a second report including the first information via the transceiver from: the UE; a network node connected with the UE after completing the inter-RAT HO procedure; or the source network node.

In some embodiments, the first information or the second report includes at least one of: information associated with a source cell of the source network node; information associated with a target cell of the target network node; a cell radio network temporary identifier (C-RNTI) of the source cell; a C-RNTI of the target cell; at least one cause associated with the at least one trigger condition; or information associated with a radio access (RA) operation of the UE.

In some embodiments, the information associated with the source cell includes at least one of: cell information associated with the source cell, or one or more measurements results of the source cell. The information associated with the target cell includes at least one of: cell information associated with the target cell, or one or more measurements results of the target cell.

In some embodiments, the second report or the first information in the second report is encoded in a RAT format of the target network node, and wherein the second report or the first information in the second report is encoded by: the UE; or the source network node.

In some embodiments, the second report is generated in response to fulfillment of a trigger condition related to a configuration regarding the first information, wherein the configuration is generated by the source network node, wherein the processor of the target network node is configured to transmit a second message via the transceiver to the source network node, and wherein the second message indicates that the second report is generated in response to the fulfillment of the trigger condition.

In some embodiments, the second message includes at least one of: at least one cause associated with the trigger condition; or an indication for indicating the fulfillment of the trigger condition.

In some embodiments, in response to receiving the second report, the processor of the target network node is configured to: encode the first information in a RAT format of the source network node; and transmit a third report including the encoded first information in the RAT format of the source network node via the transceiver to the source network node.

In some embodiments, at least one of the RAT format of the source network node or the RAT format of the target network node is one of: a format of a universal terrestrial radio access network (UTRAN); a format of an evolved UTRAN (E-UTRAN); a format of new radio (NR); and a format of a next generation.

In some embodiments, the processor of the target network node is configured to perform a mobility robustness optimization (MRO) analysis and optimization operation for parameters related to the inter-RAT HO procedure.

Some embodiments of the present application provide a network node. The network node includes a transceiver and a processor coupled to the transceiver; and the processor is configured to: receive at least one report including first information associated with a successful completion of an inter-radio access technology (RAT) handover (HO) procedure via the transceiver from a user equipment (UE), wherein the network node is connected with the UE after completing the inter-RAT HO procedure; and transfer the at least one report including the first information via the transceiver to at least one of a source network node or a target network node.

In some embodiments, the processor of the network node is configured to: receive an indication for indicating generation of the at least one report via the transceiver from the UE; and transmit a request for the at least one report or the first information via the transceiver to the UE.

In some embodiments, the processor of the network node is configured to receive at least one of cell information associated with a source cell of a source network node or cell information associated with a target cell of a target network node, and wherein a configuration related to a trigger condition for the UE logging the first information is generated by the source network node or the target network node, and wherein the cell information associated with the source cell of the source network node or the cell information associated with the target cell of the target network node includes at least one of: a public land mobile network (PLMN) identity (ID), a cell ID, a tracking area code, a physical cell identifier (PCI), or an absolute radio frequency channel number (ARFCN).

In some embodiments, the at least one of the cell information associated with the source cell of the source network node or the cell information associated with the target cell of the target network node is encoded in a RAT format of the network node.

In some embodiments, the RAT format of the network node is one of: a format of a universal terrestrial radio access network (UTRAN); a format of an evolved UTRAN (E-UTRAN); a format of new radio (NR); and a format of a next generation.

In some embodiments, the trigger condition includes one of: a ratio between a value of elapsed running time of timer T310 and a configured value of the timer T310 is greater than a first threshold generated by the source network node; a ratio between a value of elapsed running time of the timer T312 associated with the target cell of the target network node and a configured value of the timer T312 is greater than a second threshold generated by the source network node; and a ratio between a value of elapsed running time of the timer T304 and a configured value of the timer T304 is greater than a third threshold generated by the target network node.

In some embodiments, to transfer the at least one report, the processor of the network node is configured to: transfer the at least one report via the transceiver to the source network node, in response to receiving the cell information associated with the source cell of the source network node; or transfer the at least one report via the transceiver to the target network node, in response to receiving the cell information associated with the target cell of the target network node.

In some embodiments, wherein the at least one report includes a first report trigged due to fulfillment of a first trigger condition generated by the source network node and a second report trigged due to fulfillment of a second trigger condition generated by the target network node, and wherein, to transfer the at least one report, the processor of the network node is configured to: transfer the first report via the transceiver to the source network node, in response to receiving the cell information associated with the source cell of the source network node; or transfer the second report via the transceiver to the target network node, in response to receiving the cell information associated with the target cell of the target network node.

Some embodiments of the present application provide a method, which may be performed by a UE. The method includes: receiving a configuration regarding information associated with a successful completion of an inter-radio access technology (RAT) handover (HO) procedure, wherein the configuration is related to at least one trigger condition for the UE storing the information; and generating at least one report including the information in response to fulfillment of the at least one trigger condition.

Some embodiments of the present application provide a method, which may be performed by a source network node. The method includes: generating a configuration regarding information associated with a successful completion of an inter-radio access technology (RAT) handover (HO) procedure of a user equipment (UE), wherein the configuration is related to at least one trigger condition for the UE storing the information; and transmitting the configuration to the UE.

Some embodiments of the present application provide a method, which may be performed by a target network node. The method includes: generating a configuration regarding information associated with a successful completion of an inter-radio access technology (RAT) handover (HO) procedure of a user equipment (UE), wherein the configuration is related to at least one trigger condition for the UE storing the information; and transmitting the configuration to a source network node.

Some embodiments of the present application provide a method, which may be performed by a network node. The method includes: receiving at least one report including information associated with a successful completion of an inter-radio access technology (RAT) handover (HO) procedure from a user equipment (UE), wherein the network node is connected with the UE after completing the inter-RAT HO procedure; and transferring the at least one report including the information to at least one of a source network node or a target network node.

Some embodiments of the present application provide an apparatus for wireless communications. The apparatus comprises: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the abovementioned methods performed by a UE, a source network node, a target network node, or a network node.

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 illustrates an exemplary UE information procedure in accordance with some embodiments of the present application.

FIG. 3 illustrates an exemplary flow chart regarding an inter-RAT HO procedure in accordance with some embodiments of the present application.

FIG. 4 illustrates a further exemplary flow chart regarding an inter-RAT HO procedure in accordance with some embodiments of the present application.

FIG. 5 illustrates another exemplary flow chart regarding an inter-RAT HO procedure in accordance with some embodiments of the present application.

FIG. 6 illustrates yet another exemplary flow chart regarding an inter-RAT HO procedure in accordance with some embodiments of the present application.

FIG. 7 illustrates a flow chart of an exemplary procedure of wireless communications in accordance with some embodiments of the present application.

FIG. 8 illustrates a further flow chart of an exemplary procedure of wireless communications in accordance with some embodiments of the present application.

FIG. 9 illustrates another flow chart of an exemplary procedure of wireless communications in accordance with some embodiments of the present application.

FIG. 10 illustrates an exemplary block diagram of an apparatus for an inter-RAT HO procedure in accordance with some embodiments of the present application.

FIG. 11 illustrates a further exemplary block diagram of an apparatus for an inter-RAT HO procedure in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE and so on. It is contemplated that along with developments of network architectures and new service scenarios, all embodiments in the present application are also applicable to similar technical problems; and moreover, the terminologies recited in the present application may change, which should not affect the principle of the present application.

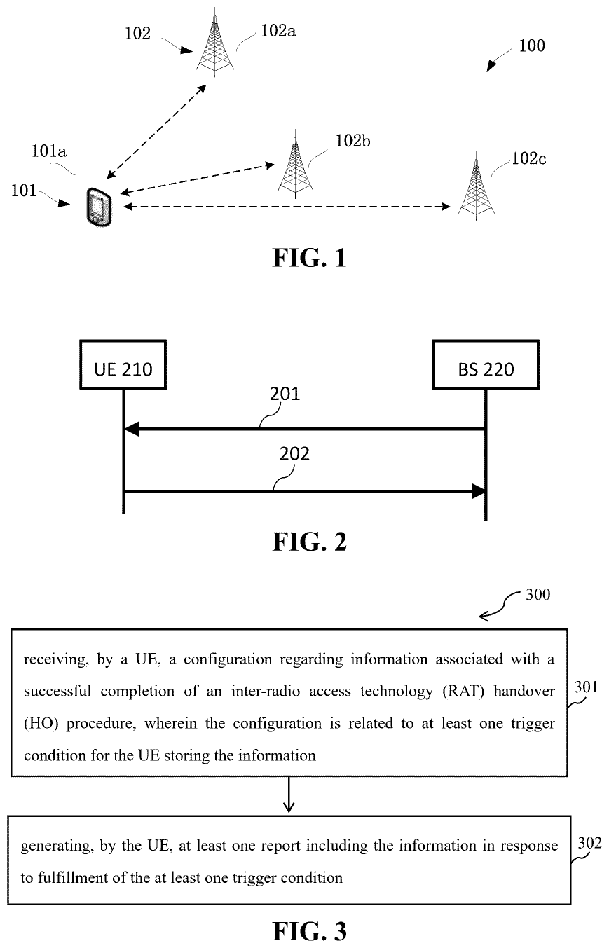

FIG. 1 illustrates a schematic diagram of a wireless communication system in accordance with some embodiments of the present application.

As illustrated and shown in FIG. 1, a wireless communication system 100 includes at least one UE 101 and at least one BS 102. In particular, the wireless communication system 100 includes one UE 101 (e.g., UE 101a) and three BSs 102 (e.g., BS 102a, BS 102b, and BS 102c) for illustrative purpose. Although a specific number of UEs 101 and BSs 102 are depicted in FIG. 1, it is contemplated that any number of UEs 101 and BSs 102 may be included in the wireless communication system 100.

UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), internet of things (IOT) devices, or the like. According to some embodiments of the present application, UE(s) 101 may include a portable wireless communication device, a smart phone, a cellular telephone, a flip phone, a device having a subscriber identity module, a personal computer, a selective call receiver, or any other device that is capable of transmitting and receiving communication signals on a wireless network. In some embodiments of the present application, UE(s) 101 includes wearable devices, such as smart watches, fitness bands, optical head-mounted displays, or the like. Moreover, UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. UE(s) 101 may communicate directly with BSs 102 via uplink (UL) communication signals.

In some embodiments of the present application, each of UE(s) 101 may be deployed an IoT application, an eMBB application and/or an URLLC application. It is contemplated that the specific type of application(s) deployed in UE(s) 101 may be varied and not limited.

BS(s) 102 may be distributed over a geographic region. In certain embodiments of the present application, each of BS(s) 102 may also be referred to as an access point, an access terminal, a base, a base unit, a macro cell, a Node-B, an evolved Node B (eNB), a gNB, a NG-RAN (Next Generation-Radio Access Network) node, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of transmitting and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G of the 3GPP protocol, wherein BS(s) 102 transmit data using an OFDM modulation scheme on the downlink (DL) and UE(s) 101 transmit data on the UL using a single-carrier frequency division multiple access (SC-FDMA) or OFDM scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 802.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of present application, BS(s) 102 may communicate with UE(s) 101 using the 3GPP 5G protocols.

Each BS(s) 102 may include one or more cells. Each UE(s) 101 may perform a cell section procedure between different cell(s) of different BS(s). Each UE(s) 101 may handover from a serving cell of a source BS to a target cell of a target BS. For example, in the wireless communication system 100 as illustrated and shown in FIG. 1, BS 102a may function as a source BS, and each of BS 102b and BS 102c may function as a target BS. If there is a handover need, UE 101a as illustrated and shown in FIG. 1 may perform a handover procedure from a serving cell of BS 102a to a target cell of BS 102b or a target cell of BS 102c, which depends a result of handover decision procedure. RAT format of a BS may be E-UTRAN or LTE access technology format, or NR access technology format, or next generation access technology format. When RAT format of a BS is E-UTRAN or LTE access technology format, the specifications of 36 series are used for communication, e.g., TS36.300, TS36.331, TS36.413, TS36.423, for example, TS36.331 is used for information encoding or decoding between UE and BS. When RAT format of a BS is NR access technology format, the specifications of 38 series are used for communication, e.g., TS38.300, TS38.331, TS38.413, TS38.423, for example, TS38.331 is used for information encoding or decoding between UE and BS. The source BS or target BS may a eNB or a gNB or a ng-eNB or a en-gNB. If the RAT of target BS is different from the RAT of source BS, an inter-RAT handover procedure is performed. Intra-system Handover means a handover that does not involve a CN change (EPC or 5GC). Inter-system Handover means a handover that involves a CN change (EPC or 5GC). For example, when source BS 102a is a gNB and target BS 102b is a ng-eNB, an intra-system inter-RAT handover is performed; when source BS 102a is a eNB and target BS 102c is a en-gNB, an intra-system inter-RAT handover is performed; when source BS 102a is a gNB and target BS 102c is a eNB, an inter-system inter-RAT handover is performed; when source BS 102a is a en-gNB and target BS 102b is a eNB, an intra-system inter-RAT handover is performed; when source BS 102a is a en-gNB and target BS 102c is a ng-eNB, an inter-system inter-RAT handover is performed. This application mainly focuses on MRO for inter-system inter-RAT handover or intra-system inter-RAT handover.

In general, regarding intra-system inter-RAT HO (Intra-5GC from NR), inter RAT mobility may be characterised by the following:
The Source RAT configures Target RAT measurement and reporting.
The source RAT decides on the preparation initiation and provides the necessary information to the target RAT in the format required by the target RAT.
For handover preparation from E-UTRA to NR, the source RAT issues a handover preparation request message to the target RAT passing a transparent RRC container with necessary information to prepare the handover at the target side. The information for the target RAT is the same type as specified in clause 9.2.3.2.1 in TS38.300 including the current QoS flow to DRB mapping applied to the UE and RRM configuration.
The details of RRM configuration are the same type as specified for NR in clause 9.2.3.2.1 in TS38.300 including beam measurement information for the listed cells if the measurements are available.
Radio resources are prepared in the target RAT before the handover.
The RRC reconfiguration message from the target RAT is delivered to the source RAT via a transparent container, and is passed to the UE by the source RAT in the handover command:
The inter-RAT handover command message carries the same type of information required to access the target cell as specified for NR baseline handover in clause 9.2.3.2.1 in TS38.300.
The in-sequence and lossless handover is supported for the handover between gNB and ng-eNB.
Both Xn and NG based inter-RAT handover between NG-RAN nodes is supported. Whether the handover is over Xn or CN is transparent to the UE.
In order to keep the SDAP and PDCP configurations for in-sequence and lossless inter-RAT handover, delta-configuration for the radio bearer configuration is used.

FIG. 2 illustrates an exemplary UE information procedure in accordance with some embodiments of the present application. The embodiments of FIG. 2 show a procedure of a UE (e.g., UE 210) communicating with a BS (e.g., BS 220). In some examples, UE 210 may function as UE 101a in FIG. 1. BS 220 may function as BS 102a, BS 102b, or BS 102c in FIG. 1.

As shown in FIG. 2, in operation 201, BS 220 (e.g., BS 102a as illustrated and shown in FIG. 1) transmits UJE Information Request message to UE 210 (e.g., UE 101a as illustrated and shown in FIG. 1). BS 220 may be a BS which controls a latest serving cell of UE 210. In operation 202, US 210 transmits UE Information Response message including a RLF report to BS 220. BS 220 can optimize a mobility problem based on the response transmitted from UE 210.

Currently, a network may initiate a UE capability transfer procedure to a UE in an RRC_CONNECTED state when it needs (additional) UE radio access capability information. The network should retrieve UE capabilities only after AS security activation, e.g., via a UE capability enquiry message. The network does not forward UE capabilities that were retrieved before AS security activation to the core network (CN). The UE compiles and transfers its UE capability information upon receiving a UE capability enquiry message from the network, e.g., via a UE capability information message.

In general, there is no mechanism for storing or reporting information associated with a successful inter-RAT HO procedure. Several related issues have not been discussed and need to be solved, for example: (1) how to trigger to store or report information associated with a successful inter-RAT HO procedure and what is a trigger condition; (2) how a UE logs or reports information associated with an inter-RAT HO procedure, especially, for the case that multiple triggering conditions for storing or reporting successful inter-RAT HO related information are met; (3) how a network performs a MRO analysis for the inter-RAT HO procedure, especially for the case that multiple triggering conditions for storing or reporting successful inter-RAT HO related information are met, e.g., a signalling procedure for exchanging inter-node information.

Embodiments of the present application aim to solve the above issues. Some embodiments of the present application provide solutions in which configuration(s) for storing, recording, logging, or generating information associated with an inter-RAT HO procedure may be configured to a UE via a RRC message, e.g., via a MobilityFromNRCommand message for inter-RAT handover from NR to E-UTRAN. The UE may store, record, log, or generate at least one variable or report to contain the information associated with an inter-RAT HO procedure when at least one configured trigger condition is fulfilled. Some embodiments of the present application provide solutions in which multiple trigger conditions generated by a source network node and a target network node separately are fulfilled for the same inter-RAT HO procedure.

In some embodiments of the present application, a UE may generate multiple reports separately, each report is associated with one trigger condition, and each report is encoded based on the RAT type of the node which generates the corresponding trigger condition. In some embodiments of the present application, each report and information associated with a cell which generates the associated trigger condition for the report are reported separately, and the receiving node may transfer each received report to the corresponding node for a MRO purpose separately based on the received information associated with the cell.

In some embodiments of the present application, a UE only generates one report which is encoded in a format of a target network node. The report encoded in the format of the target network node and information associated with a target cell which is encoded in the format of the receiving network node are reported, and the receiving node may transfer the received report to the target network node for a MRO purpose based on the information associated with the target cell. When the target network node detects that information associated with an inter-RAT HO procedure is triggered due to fulfillment of a trigger condition generated by a source network node, the target network node may inform the detected information to the source network node for a MRO purpose.

In some embodiments of the present application, a UE only generates one report which is encoded in a format of a source network node. The report encoded in the format of the source network node and information associated with the source cell which is encoded in the format of the receiving node are reported, and the receiving node transfers the received report to the source network node for a MRO purpose based on the information associated with the source cell. When the source network node detects that information associated with an inter-RAT HO procedure is triggered due to fulfillment of a trigger condition generated by a target network node, a source network node informs the detected information to a target network node for a MRO purpose.

More details will be illustrated in the following text in combination with the appended drawings. Persons skilled in the art should well know that the wording “a/the first,” “a/the second” and “a/the third” etc. are only used for clear description, and should not be deemed as any substantial limitation, e.g., sequence limitation. In the present application, information or a report encoded in NR format means that the information or the report is encoded based on 3GPP TS38.331. In the present application, information or a report encoded in LTE format means that the information or the report is encoded based on 3GPP TS36.331.

FIG. 3 illustrates an exemplary flow chart regarding an inter-RAT HO procedure in accordance with some embodiments of the present application. The method 300 may be performed by a UE (e.g., UE 101 or UE 210 as shown and illustrated in FIG. 1 or FIG. 2). Although described with respect to a UE, it should be understood that other devices may also be configured to perform the method as shown and illustrated in FIG. 3.

In the exemplary method 300 as shown in FIG. 3, in operation 301, a UE (e.g., UE 101 as shown and illustrated in FIG. 1) receives a configuration regarding information associated with a successful completion of an inter-RAT HO procedure. The configuration is related to at least one trigger condition for the UE storing the information. In operation 302, the UE generates at least one report including the information in response to fulfillment of the at least one trigger condition. The information may be denoted as “the first information” for simplicity. For example, information associated with a successful completion of an inter-RAT HO procedure may be included in a report, e.g., which is named as an inter-RAT successful handover report (SHR).

In some embodiments, the UE may transmit an indication for indicating an optional capability of the UE for storing the first information.

In some embodiments, the configuration is generated by at least one of a source network node or a target network node. In an embodiment, in response to the configuration generated by the source network node, the at least one trigger condition includes:
(1) a ratio between a value of elapsed running time of timer T310 and a configured value of the timer T310 is greater than a threshold generated by the source network node (which may be denoted as “the first threshold” for simplicity); or
(2) a ratio between a value of elapsed running time of the timer T312 associated with a target cell and a configured value of the timer T312 is greater than a threshold generated by the source network node (which may be denoted as “the second threshold” for simplicity).

In an embodiment, in response to the configuration generated by the target network node, the at least one trigger condition includes: a ratio between a value of elapsed running time of the timer T304 and a configured value of the timer T304 is greater than a threshold generated by the target network node (which may be denoted as “the third threshold” for simplicity). In an embodiment, the configuration includes at least one of: the first threshold; the second threshold; or the third threshold.

In particular, for the successful inter-RAT HO reporting, when a network knows the UE's capability, configurations (e.g., successInterRATHO-Config IE) for the UE to store, log, record, generate or report the inter-RAT SHR can be configured by the network, e.g., via the MobilityFromNRCommand message for inter-RAT handover from NR to E-UTRAN, or via the MobilityFromEUTRACommand message for inter-RAT handover from E-UTRAN to NR. For instance, the configurations may include at least one of:
(1) timer T304 related condition for triggering the inter-RAT SHR (for example, the third threshold, e.g., interRATthresholdPercentageT304, generated by a target RAT, e.g., a target network node);
(2) timer T310 related condition for triggering the inter-RAT SHR (for example, the first threshold, e.g., interRATthresholdPercentageT310, generated by a source RAT, e.g., a source network node); and
(3) timer T312 related condition for triggering the inter-RAT SHR (for example, the second threshold, e.g., interRATthresholdPercentageT312, generated by the source RAT).

Based on the configurations for storing, logging, recording, or generating the inter-RAT SHR configured by the network, the UE may need to store, log, record, or generate the successful inter-RAT HO related information when at least one of the following trigger conditions for the inter-RAT SHR is fulfilled:
(1) Condition 1: if a ratio between “the value of the elapsed time of timer T310” and “the configured value of timer T310, configured while the UE was connected to the source RAT before executing the last inter-RAT HO” is greater than a threshold (e.g., the first threshold (e.g., interRATthresholdPercentageT310) included in the successInterRATHO-Config IE) configured or generated by the source RAT before executing the last inter-RAT HO. Condition 1, e.g., the first threshold, may be generated or configured by the source RAT.
(2) Condition 2: if timer T312 associated to the measurement identity of the target cell was running at the time of initiating the inter-RAT HO procedure and if a ratio between “the value of the elapsed time of timer T312” and “the configured value of timer T312, configured while the UE was connected to the source RAT before executing the last inter-RAT HO” is greater than a threshold (e.g., the second threshold (e.g., interRATthresholdPercentageT312) included in the successInterRATHO-Config IE) configured or generated by the source RAT before executing the last inter-RAT HO procedure. Condition 2, e.g., the second threshold, may be generated or configured by the source RAT.
(3) Condition 3: if a ratio between “the value of the elapsed time of timer T304” and “the configured value of timer T304 (included in the last MobilityFromNRCommand message or MobilityFromEUTRACommand message)” is greater than a threshold (e.g., the third threshold (e.g., interRATthresholdPercentageT304) included in the successInterRATHO-Config IE) received in the last MobilityFromNRCommand message or MobilityFromEUTRACommand message, before executing the last inter-RAT HO procedure. Condition 3, e.g., the third threshold, may be generated or configured by the target RAT.

When one of Condition 1, Condition 2, and Condition 3 are fulfilled, the UE may generate a variable (for example, VarInterRATSuccessHO-Report IE), in which the UE may store, log, record, or generate the successful inter-RAT HO related information, e.g., in the variable or in InterRATSuccessHO-Report.

In some embodiments, the UE may indicate to the connected node or the newest serving node that it has stored, logged, recorded, or generated the successful inter-RAT HO related information, e.g., via an indication included in an RRC setup complete message, or an RRC resume complete message, or an RRC reconfiguration complete message. If the network wants to get the inter-RAT SHR or successful inter-RAT HO related information, the connected node may send a message to the UE to request the stored, logged, recorded, or generated successful inter-RAT HO related information, e.g., via an indication included in a UE information request message. Then, the UE may send the stored, logged, recorded, or generated successful inter-RAT HO related information (e.g., InterRATSuccessHO-Report) to the network, e.g., via a UE information response message.

The UE variable (e.g., VarInterRATSuccessHO-Report IE) for storing, logging, recording, or generating the successful inter-RAT HO related information, or the InterRATSuccessHO-Report, the successful inter-RAT HO related information, or the “the first information” can include at least one of the following:
(1) information associated with a source cell of a source network node, which may also be named as “source cell information” or the like, including CGI information of the source cell (e.g., PLMN-Identity, Cell Identity and TrackingAreaCode, or, PCI and ARFCN), and measurements results of the source cell, e.g., when the inter-RAT HO procedure is executed or when the inter-RAT HO procedure is successful. For example, source cell information may be information of a source cell of source BS 702, information of a source cell of source BS 802, or information of a source cell of source BS 902 in the embodiments of any of FIGS. 7-9.
(2) information associated with a target cell of a target network node, which may also be named as “target cell information” or the like, including CGI information of the target cell (e.g., PLMN-Identity, Cell Identity and TrackingAreaCode, or, PCI and ARFCN), and measurements results of the target cell, e.g., when the inter-RAT HO procedure is executed or when the inter-RAT HO procedure is successful. For example, target cell information may be information of a target cell of target BS 703, information of a target cell of target BS 803, or information of a target cell of target BS 903 in the embodiments of any of FIGS. 7-9.
(3) InterRATSHR-Cause, including cause(s) associated with the trigger condition(s). For example, if Condition 1 is fulfilled, t310-cause or interRATt310-cause set to “true” may be included in the InterRATSuccessHO-Report. If Condition 2 is fulfilled, t312-cause or interRATt312-cause set to “true” may be included in the InterRATSuccessHO-Report. If Condition 3 is fulfilled, t304-cause or interRATt304-cause set to “true” may be included in the InterRATSuccessHO-Report.
(4) C-RNTI of the target cell.
(5) RA-InformationCommon, including information associated with an RA operation of the UE. For example, it can be included in InterRATSuccessHO-Report, when Condition 3 is fulfilled.

For triggering the inter-RAT SHR, one or more trigger conditions can be configured, e.g., only Condition 1 is configured, only Condition 3 is configured, Condition 1 and Condition 3 are configured simultaneously, Condition 2 and Condition 3 are configured simultaneously, or etc. In some embodiments, how the UE logs or reports inter-RAT SHR, and how network performs MRO analysis for inter-RAT SHR are provided, especially for the case that multiple triggering conditions for storing, logging, recording, or generating successful inter-RAT HO related information are fulfilled, e.g., both one condition generated or configured by the target RAT and another condition generated or configured by the source RAT are met for the same inter-RAT HO procedure.

Referring back to FIG. 3, in some embodiments, the at least one trigger condition includes two or more trigger conditions. In response to fulfillment of the two or more trigger conditions, the UE may generate two or more reports including the first information or generate only one report including the first information. That is, the at least one report may include two or more reports or only one report.

In some embodiments, each report within the at least one report or the first information includes at least one of:
(1) Information associated with a source cell of a source network node, i.e., “source cell information”. In some embodiments, the information associated with the source cell includes at least one of: cell information associated with the source cell, or one or more measurements results of the source cell.
(2) Information associated with a target cell of a target network node, i.e., “target cell information”. In some embodiments, the information associated with the target cell includes at least one of: cell information associated with the target cell, or one or more measurements results of the target cell.
(3) A C-RNTI of the source cell.
(4) A C-RNTI of the target cell.
(5) At least one cause associated with the at least one trigger condition.
(6) information associated with a RA operation of the UE.

In some embodiments, one report within the two or more reports is associated with one trigger condition within the two or more trigger conditions. In an embodiment, the UE may encode the one report or the first information within the one report based on a RAT type of a network node which generates the one trigger condition for the UE storing the first information within the one report. For instance, the one report or the first information within the one report is encoded in a RAT format of a source network node (which may be named as, e.g., the source RAT format) or a RAT format of a target network node (which may be named as, e.g., the target RAT format). The RAT format of the source network node or target network node may be UTRAN or UMTS access technology format, E-UTRAN or LTE access technology format, NR access technology format, or next generation access technology format. For example, when the RAT format of the source network node is NR access technology format, “the one report or the first information within the one report is encoded in a RAT format of a source network node (which may be named as, e.g., the source RAT format)” means that the one report or the first information within the one report is encoded based on TS38.331, or the UE encodes the one report or the first information within the one report following TS38.331; when the RAT format of the target network node is E-UTRAN or LTE access technology format, “the one report or the first information within the one report is encoded in a RAT format of a target network node (which may be named as, e.g., the target RAT format)” means that the one report or the first information within the one report is encoded based on TS36.331, or the UE encodes the one report or the first information within the one report following TS36.331.

In some embodiments, the UE may generate further information associated with a cell of a network node (which may be denoted as “the second information” for simplicity). The network node is the one which generates the one trigger condition for the UE storing the first information within the one report. The UE may transmit the one report and the second information to a network node which is connected with the UE after completing the inter-RAT HO procedure. For example, for one report which is generated or reported due to one trigger condition generated by the source network node is fulfilled, the UE may generate the second information associated with the source cell; for one report which is generated or reported due to one trigger condition generated by the target network node is fulfilled, the UE may generate the second information associated with the target cell. The second information includes at least one of:
(1) a public land mobile network (PLMN) identity (ID),
(2) a cell ID,
(3) a tracking area code,
(4) a physical cell identifier (PCI), or
(5) an absolute radio frequency channel number (ARFCN).

In some embodiments, the UE may encode the second information in a RAT format of the network node which is connected with the UE. Specific examples are described in embodiments of FIG. 7 as follows.

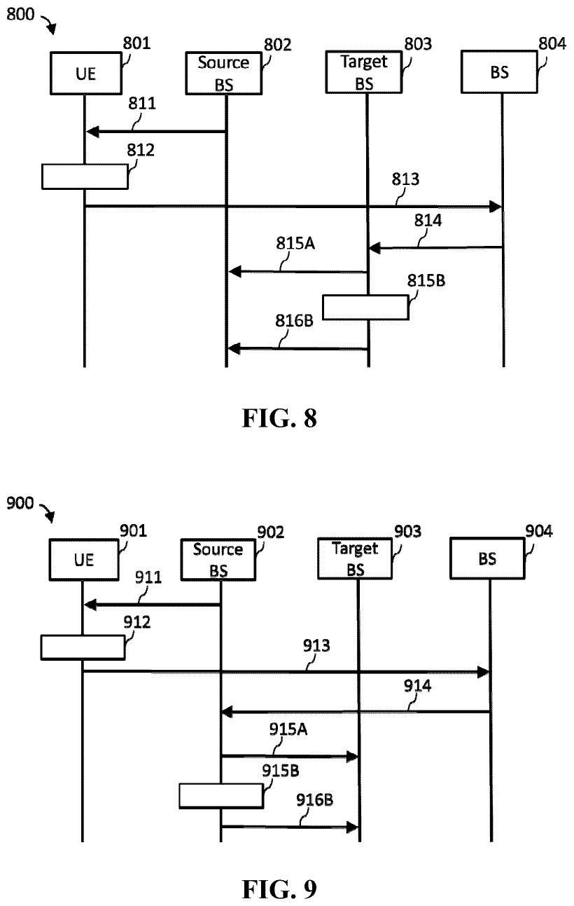

In some embodiments, the UE may encode the only one report or the first information included in the only one report based on a RAT type of a target network node. The RAT format of the target network node may be UTRAN or UMTS access technology format, E-UTRAN or LTE access technology format, NR access technology format, or next generation access technology format. For example, when the RAT format of the target network node is NR access technology format, “the UE may encode the only one report or the first information included in the only one report based on a RAT type of a target network node” means that only one report or the first information included in the only one report is encoded based on TS38.331, or the UE encodes the only one report or the first information included in the only one report following TS38.331; when the RAT format of the target network node is E-UTRAN or LTE access technology format, “the UE may encode the only one report or the first information included in the only one report based on a RAT type of a target network node” means that the only one report or the first information included in the only one report is encoded based on TS36.331, or the UE encodes the only one report or the first information included in the only one report following TS36.331. In an embodiment, the UE may generate cell information associated with a target cell of the target network node, and transmit the only one report and the cell information associated with the target cell to a network node connected with the UE after completing the inter-RAT HO procedure. The cell information associated with the target cell includes at least one of: a PLMN ID, a cell ID, a tracking area code, a PCI, or an ARFCN. For instance, the UE may encode the cell information associated with the target cell in a RAT format of the network node which is connected with the UE. The network node connected with the UE after completing the inter-RAT HO procedure may be the source network node or the target network node or a third party network node which is different from the source network node and the target network node. The RAT format of the network node which is connected with the UE after completing the inter-RAT HO procedure may be E-UTRAN or LTE access technology format, NR access technology format, or next generation access technology format. For example, when the RAT format of the network node which is connected with the UE after completing the inter-RAT HO procedure is NR access technology format, “the UE may encode the cell information associated with the target cell in a RAT format of the network node which is connected with the UE” means that the cell information associated with the target cell is encoded based on TS38.331, or the UE encodes the cell information associated with the target cell following TS38.331; when the RAT format of the network node which is connected with the UE after completing the inter-RAT HO procedure is E-UTRAN or LTE access technology format, “the UE may encode the cell information associated with the target cell in a RAT format of the network node which is connected with the UE” means that the cell information associated with the target cell is encoded based on TS36.331, or the UE encodes the cell information associated with the target cell following TS36.331. Specific examples are described in embodiments of FIG. 8 as follows.

In some embodiments, the UE may encode the only one report or the first information included in the only one report based on a RAT type of a source network node. The RAT format of the source network node may be UTRAN or UMTS access technology format, E-UTRAN or LTE access technology format, NR access technology format, or next generation access technology format. For example, when the RAT format of the source network node is NR access technology format, “the UE may encode the only one report or the first information included in the only one report based on a RAT type of a source network node” means that only one report or the first information included in the only one report is encoded based on TS38.331, or the UE encodes the only one report or the first information included in the only one report following TS38.331; when the RAT format of the source network node is E-UTRAN or LTE access technology format, “the UE may encode the only one report or the first information included in the only one report based on a RAT type of a source network node” means that the only one report or the first information included in the only one report is encoded based on TS36.331, or the UE encodes the only one report or the first information included in the only one report following TS36.331. In an embodiment, the UE may generate cell information associated with a source cell of the source network node, and transmit the only one report and the cell information associated with the source cell to a network node which is connected with the UE after completing the inter-RAT HO procedure. The cell information associated with the source cell includes at least one of: a PLMN ID, a cell ID, a tracking area code, a PCI, or an ARFCN. For instance, the UE may encode the cell information associated with the source cell in a RAT format of the network node which is connected with the UE. The RAT format of the network node which is connected with the UE after completing the inter-RAT HO procedure may be E-UTRAN or LTE access technology format, NR access technology format, or next generation access technology format. For example, when the RAT format of the network node which is connected with the UE after completing the inter-RAT HO procedure is NR access technology format, “the UE may encode the cell information associated with the source cell in a RAT format of the network node which is connected with the UE” means that the cell information associated with the source cell is encoded based on TS38.331, or the UE encodes the cell information associated with the source cell following TS38.331; when the RAT format of the network node which is connected with the UE after completing the inter-RAT HO procedure is E-UTRAN or LTE access technology format, “the UE may encode the cell information associated with the source cell in a RAT format of the network node which is connected with the UE” means that the cell information associated with the source cell is encoded based on TS36.331, or the UE encodes the cell information associated with the source cell following TS36.331. Specific examples are described in embodiments of FIG. 9 as follows.

In some embodiments, at least one of the RAT format of the source network node, the RAT format of the target network node, or the RAT format of the network node which is connected with the UE is one of:
(1) a format of an universal terrestrial radio access network (UTRAN);
(2) a format of an evolved UTRAN (E-UTRAN);
(3) a format of new radio (NR); and
(4) a format of a next generation.

In some embodiments, the UE may transmit an indication for indicating generation of the at least one report to a network node connected with the UE after completing the inter-RAT HO procedure; receive a request for the at least one report or the first information from the network node; and transmit the at least one report to the network node. In the present application, the network node connected with the UE after completing the inter-RAT HO procedure may be the target network node (e.g., when the UE successfully handovers to the target RAT, the UE transmits an indication for indicating generation of the at least one report or information associated with a successful completion of an inter-RAT HO procedure via the transceiver to the target network node, the target network node requests the UE for the at least one report or information associated with a successful completion of an inter-RAT HO procedure, then the UE transmit the at least one report or information associated with a successful completion of an inter-RAT HO procedure to the target network node); or the network node connected with the UE after completing the inter-RAT HO procedure may be the source network node (e.g., the UE moves to or connects with the source network node after completing the inter-RAT HO procedure, the UE transmits an indication for indicating generation of the at least one report or information associated with a successful completion of an inter-RAT HO procedure via the transceiver to the source network node, the source network node requests the UE for the at least one report or information associated with a successful completion of an inter-RAT HO procedure, then, the UE transmits the at least one report or information associated with a successful completion of an inter-RAT HO procedure to the source network node); or the network node connected with the UE after completing the inter-RAT HO procedure may be a third party network node which is different from the source network node and the target network node (e.g., the UE moves to or connects with the third party network node after completing the inter-RAT HO procedure, the UE transmits an indication for indicating generation of the at least one report or information associated with a successful completion of an inter-RAT HO procedure via the transceiver to the third party network node, the third party network node requests the UE for the at least one report or information associated with a successful completion of an inter-RAT HO procedure, then, the UE transmits the at least one report or information associated with a successful completion of an inter-RAT HO procedure to the third party network node).

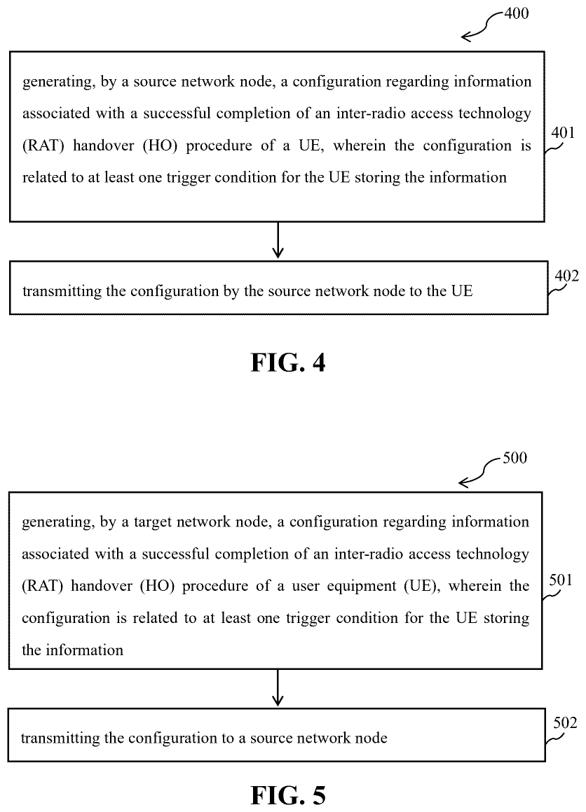

FIG. 4 illustrates a further exemplary flow chart regarding an inter-RAT HO procedure in accordance with some embodiments of the present application. The exemplary method 400 in FIG. 4 may be performed by a source network node, e.g., BS 102a as shown in FIG. 1. Although described with respect to a source network node, it should be understood that other devices may be configured to perform a method similar to that of FIG. 4.

In the exemplary method 400 as shown in FIG. 4, in operation 401, a source network node (e.g., BS 102a as shown and illustrated in FIG. 1) generates a configuration regarding information (which may be denoted as “the first information” for simplicity) associated with a successful completion of an inter-RAT HO procedure of a UE (e.g., UE 101 as shown and illustrated in FIG. 1). The configuration is related to at least one trigger condition for the UE storing the information. In operation 402, the source network node transmits the configuration to the UE. In some embodiments, the configuration includes at least one of: a threshold associated with timer T310; or a threshold associated with timer T312.

In some embodiments, the at least one trigger condition includes one of:
(1) a ratio between a value of elapsed running time of timer T310 and a configured value of the timer T310 is greater than the first threshold;
(2) a ratio between a value of elapsed running time of the timer T312 associated with a target cell and a configured value of the timer T312 is greater than the second threshold; and
(3) a ratio between a value of elapsed running time of the timer T304 and a configured value of the timer T304 is greater than the third threshold.

In some embodiments, the source network node may receive a second configuration regarding the first information from a target network node, and transmit the second configuration to the UE. The second configuration may include a threshold associated with timer T304. The first configuration and the second configuration may be transmitted in one message or two messages. In an embodiment, at least one of the first configuration or the second configuration is included in a handover command for the inter-RAT HO procedure.

In some embodiments, the source network node may receive an indication for indicating an optional capability of the UE for storing the first information from the UE. In particular, since pre-configuration (e.g., successInterRATHO-Config IE) for the UE to store, log, report, generate or report the inter-RAT SHR is required, the network needs to know the UE's capability, in order to configure proper configuration(s) to trigger the successful inter-RAT HO report. Storing, logging, reporting, generating or reporting of the successful inter-RAT HO related information is optional, even if the UE supports the inter-RAT HO procedure. This capability may be explicitly signalled to the network, i.e., explicit capability signalling is needed, or optional UE's capability with signalling is needed. Some embodiments introduce an optional UE capability with signalling for successful inter-RAT HO report, for example, UECapabilityInformation message includes an optional UE capability indication for the successful inter-RAT HO report. Some embodiments reuse the existing optional UE capability indication for the successful HO report, i.e., success-HO-Report-r17, in a UECapabilityInformation message, for the inter-RAT HO scenario.

In some embodiments, the source network node may receive a first report including the first information from a network node connected with the UE after completing the inter-RAT HO procedure (specific examples are described in embodiments of FIGS. 7 and 9 as follows) or a target network node (specific examples are described in embodiments of FIG. 8 as follows). The network node connected with the UE after completing the inter-RAT HO procedure may be the source network node or the target network node or a third party network node which is different from the source network node and the target network node. In an embodiment, the first report or the first information includes at least one of:
(1) Information associated with a source cell of the source network node. In some embodiments, the information associated with the source cell includes at least one of: cell information associated with the source cell, or one or more measurements results of the source cell.
(2) Information associated with a target cell of the target network node. In some embodiments, the information associated with the target cell includes at least one of: cell information associated with the target cell, or one or more measurements results of the target cell.
(3) A cell radio network temporary identifier (C-RNTI) of the source cell.
(4) A C-RNTI of the target cell.
(5) At least one cause associated with the at least one trigger condition.
(6) Information associated with a radio access (RA) operation of the UE.

In some embodiments, the first report or the first information in the first report is encoded in a RAT format of the source network node. The RAT format of the source network node may be UTRAN or UMTS access technology format, E-UTRAN or LTE access technology format, NR access technology format, or next generation access technology format. For example, when the RAT format of the source network node is NR access technology format, “the first report or the first information in the first report is encoded in a RAT format of the source network node” means that the first report or the first information in the first report is encoded based on TS38.331; when the RAT format of the source network node is E-UTRAN or LTE access technology format, “the first report or the first information in the first report is encoded in a RAT format of the source network node” means that the first report or the first information in the first report is encoded based on TS36.331. In an embodiment, the first report or the first information is encoded by the UE (specific examples are described in embodiments of FIGS. 7 and 9 as follows) or by the target network node (specific examples are described in embodiments of FIG. 8 as follows).

In some embodiments, the first report is generated in response to fulfillment of a trigger condition related to the second configuration, the source network node may transmit a first message to a target network node, and the first message indicates that the first report is generated in response to the fulfillment of the trigger condition related to the second configuration.

In some embodiments, the first message includes at least one of: at least one cause associated with the trigger condition related to the second configuration; or an indication for indicating the fulfillment of the trigger condition related to the second configuration.

In some embodiments, in response to receiving the first report, the source network node may encode the first information in a RAT format of the target network node; and transmit a second report including the encoded first information in the RAT format of the target network node to the target network node. The RAT format of the target network node may be UTRAN or UMTS access technology format, E-UTRAN or LTE access technology format, NR access technology format, or next generation access technology format. For example, when the RAT format of the target network node is NR access technology format, “the first information in a RAT format of the target network node” or “a second report including the encoded first information in the RAT format of the target network node” means that the first information or the second report is encoded based on TS38.331; when the RAT format of the target network node is E-UTRAN or LTE access technology format, “the first information in a RAT format of the target network node” or “a second report including the encoded first information in the RAT format of the target network node” means that the first information or the second report is encoded based on TS36.331. Specific examples are described in embodiments of FIG. 9 as follows.

In some embodiments, at least one of the RAT format of the source network node or the RAT format of the target network node is one of: a format of a universal terrestrial radio access network (UTRAN); a format of an evolved UTRAN (E-UTRAN); a format of new radio (NR); and a format of a next generation.

In some embodiments, the source network node may receive a second message from a target network node, and wherein the second message indicates that the first information is stored in response to fulfillment of a trigger condition related to the first configuration.

In some embodiments, the second message includes at least one of: at least one cause associated with the trigger condition related to the first configuration; or an indication for indicating the fulfillment of the trigger condition related to the first configuration. Specific examples are described in embodiments of FIG. 8 as follows.

In some embodiments, the source network node may perform a mobility robustness optimization (MRO) analysis and optimization operation for parameters related to the inter-RAT HO procedure. Specific examples are described in embodiments of FIG. 7 as follows.

FIG. 5 illustrates another exemplary flow chart regarding an inter-RAT HO procedure in accordance with some embodiments of the present application. The exemplary method 400 in FIG. 5 may be performed by a target network node, e.g., BS 102b or BS 102c as shown in FIG. 1. Although described with respect to a target network node, it should be understood that other devices may be configured to perform a method similar to that of FIG. 5.

In the exemplary method 500 as shown in FIG. 5, in operation 501, a target network node (e.g., BS 102b as shown and illustrated in FIG. 1) generating a configuration regarding information associated with a successful completion of an inter-RAT HO procedure of a UE (e.g., UE 101 as shown and illustrated in FIG. 1). The configuration is related to at least one trigger condition for the UE storing the information. In operation 502, the target network node transmits the configuration to a source network node.

In some embodiments, the second configuration includes a third threshold associated with timer T304.

In some embodiments, the at least one trigger condition includes one of: a ratio between a value of elapsed running time of timer T310 and a configured value of the timer T310 is greater than a first threshold generated by the source network node; a ratio between a value of elapsed running time of the timer T312 associated with a target cell and a configured value of the timer T312 is greater than a second threshold generated by the source network node; and a ratio between a value of elapsed running time of the timer T304 and a configured value of the timer T304 is greater than the third threshold.

In some embodiments, the target network node may receive an indication for indicating an optional capability of the UE for storing the first information from the source network node.

In some embodiments, the target network node may receive a first message from the source network node, and the first message indicates that the first information is stored in response to fulfillment of a trigger condition related to the second configuration. Specific examples are described in embodiments of FIG. 9 as follows.

In some embodiments, the first message includes at least one of: at least one cause associated with the trigger condition related to the second configuration; or an indication for indicating the fulfillment of the trigger condition related to the second configuration.

In some embodiments, the target network node may receive an indication for indicating generation of at least one report including the first information from the UE; and transmit a request for the at least one report or the first information to the UE.

In some embodiments, the target network node may receive a second report including the first information from: the UE; a network node connected with the UE after completing the inter-RAT HO procedure; or the source network node. The network node connected with the UE after completing the inter-RAT HO procedure may be the source network node or the target network node or a third party network node which is different from the source network node and the target network node.

In some embodiments, the first information or the second report includes at least one of:
(1) Information associated with a source cell of the source network node. In some embodiments, the information associated with the source cell includes at least one of: cell information associated with the source cell, or one or more measurements results of the source cell.
(2) Information associated with a target cell of the target network node. In some embodiments, the information associated with the target cell includes at least one of: cell information associated with the target cell, or one or more measurements results of the target cell.
(3) A cell radio network temporary identifier (C-RNTI) of the source cell.
(4) A C-RNTI of the target cell; at least one cause associated with the at least one trigger condition.
(5) Information associated with a radio access (RA) operation of the UE.

In some embodiments, the second report or the first information in the second report is encoded in a RAT format of the target network node, and wherein the second report or the first information in the second report is encoded by: the UE; or the source network node. The RAT format of the target network node may be UTRAN or UMTS access technology format, E-UTRAN or LTE access technology format, NR access technology format, or next generation access technology format. For example, when the RAT format of the target network node is NR access technology format, “the second report or the first information in the second report is encoded in a RAT format of the target network node” means that the second report or the first information in the second report is encoded based on TS38.331; when the RAT format of the target network node is E-UTRAN or LTE access technology format, “the second report or the first information in the second report is encoded in a RAT format of the target network node” means that the second report or the first information in the second report is encoded based on TS36.331.

In some embodiments, the second report is generated in response to fulfillment of a trigger condition related to a configuration regarding the first information. The configuration is generated by the source network node. The target network node may transmit a second message to the source network node. The second message indicates that the second report is generated in response to the fulfillment of the trigger condition.

In some embodiments, the second message includes at least one of: at least one cause associated with the trigger condition; or an indication for indicating the fulfillment of the trigger condition.

In some embodiments, in response to receiving the second report, the target network node may encode the first information in a RAT format of the source network node; and transmit a third report including the encoded first information in the RAT format of the source network node to the source network node. The RAT format of the source network node may be UTRAN or UMTS access technology format, E-UTRAN or LTE access technology format, NR access technology format, or next generation access technology format. For example, when the RAT format of the source network node is NR access technology format, “the first information in a RAT format of the source network node” or “a third report including the encoded first information in the RAT format of the source network node” means that the first information or the third report is encoded based on TS38.331; when the RAT format of the source network node is E-UTRAN or LTE access technology format, “the first information in a RAT format of the source network node” or “a third report including the encoded first information in the RAT format of the source network node” means that the first information or the third report is encoded based on TS36.331. Specific examples are described in embodiments of FIG. 8 as follows.

In some embodiments, at least one of the RAT format of the source network node or the RAT format of the target network node is one of: a format of a universal terrestrial radio access network (UTRAN); a format of an evolved UTRAN (E-UTRAN); a format of new radio (NR); and a format of a next generation.

In some embodiments, the target network node may perform a mobility robustness optimization (MRO) analysis and optimization operation for parameters related to the inter-RAT HO procedure. Specific examples are described in embodiments of FIG. 7 as follows.

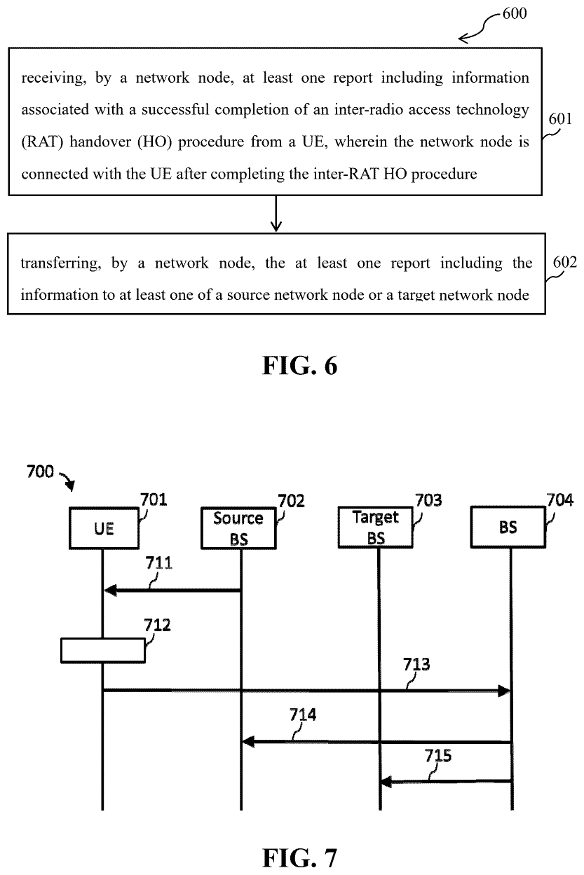

FIG. 6 illustrates yet another exemplary flow chart regarding an inter-RAT HO procedure in accordance with some embodiments of the present application. The exemplary method 600 in FIG. 6 may be performed by a network node, e.g., BS 102a, BS 102b, or BS 102c as shown in FIG. 1. Although described with respect to a network node, it should be understood that other devices may be configured to perform a method similar to that of FIG. 6

In the exemplary method 600 as shown in FIG. 6, in operation 601, a network node (e.g., BS 102b as shown and illustrated in FIG. 1) receives at least one report including information associated with a successful completion of an inter-RAT HO procedure from a UE (e.g., UE 101 as shown and illustrated in FIG. 1). The network node is connected with the UE after completing the inter-RAT HO procedure. The network node connected with the UE after completing the inter-RAT HO procedure may be the source network node or the target network node or a third party network node which is different from the source network node and the target network node. In operation 602, the network node transfers the at least one report including the information to at least one of a source network node or a target network node.

In some embodiments, the network node may receive an indication for indicating generation of the at least one report from the UE; and transmit a request for the at least one report or the first information to the UE.

In some embodiments, the network node may receive at least one of cell information associated with a source cell of a source network node or cell information associated with a target cell of a target network node, and wherein a configuration related to a trigger condition for the UE logging the first information is generated by the source network node or the target network node, and wherein the cell information associated with the source cell of the source network node or the cell information associated with the target cell of the target network node includes at least one of: a public land mobile network (PLMN) identity (ID), a cell ID, a tracking area code, a physical cell identifier (PCI), or an absolute radio frequency channel number (ARFCN).

In some embodiments, the at least one of the cell information associated with the source cell of the source network node or the cell information associated with the target cell of the target network node is encoded in a RAT format of the network node which is connected with the UE after completing the inter-RAT HO procedure. The RAT format of the network node which is connected with the UE after completing the inter-RAT HO procedure may be E-UTRAN or LTE access technology format, NR access technology format, or next generation access technology format. For example, when the RAT format of the network node which is connected with the UE after completing the inter-RAT HO procedure is NR access technology format, “the at least one of the cell information associated with the source cell of the source network node or the cell information associated with the target cell of the target network node is encoded in a RAT format of the network node which is connected with the UE after completing the inter-RAT HO procedure” means that the cell information associated with the source cell or the cell information associated with the target cell is encoded based on TS38.331; when the RAT format of the network node which is connected with the UE after completing the inter-RAT HO procedure is E-UTRAN or LTE access technology format, “the at least one of the cell information associated with the source cell of the source network node or the cell information associated with the target cell of the target network node is encoded in a RAT format of the network node which is connected with the UE after completing the inter-RAT HO procedure” means that the cell information associated with the source cell or the cell information associated with the target cell is encoded based on TS36.331.

In some embodiments, the RAT format of the network node is one of: a format of an UTRAN; a format of an E-UTRAN; a format of NR; and a format of a next generation.

In some embodiments, the trigger condition includes one of: a ratio between a value of elapsed running time of timer T310 and a configured value of the timer T310 is greater than a first threshold generated by the source network node; a ratio between a value of elapsed running time of the timer T312 associated with the target cell of the target network node and a configured value of the timer T312 is greater than a second threshold generated by the source network node; and a ratio between a value of elapsed running time of the timer T304 and a configured value of the timer T304 is greater than a third threshold generated by the target network node.

In some embodiments, to transfer the at least one report, the network node may transfer the at least one report to the source network node, in response to receiving the information associated with the source cell of the source network node; or transfer the at least one report to the target network node, in response to receiving the information associated with the target cell of the target network node.

In some embodiments, the at least one report includes: one report trigged due to fulfillment of a trigger condition generated by the source network node, and another report trigged due to fulfillment of a trigger condition generated by the target network node. The network node may transfer the one report to the source network node, in response to receiving the cell information associated with the source cell of the source network node. The network node may transfer the another report to the target network node, in response to receiving the cell information associated with the target cell of the target network node.

It should be appreciated by persons skilled in the art that the sequence of the operations in the exemplary flowcharts 300, 400, 500, and 600 may be changed, and some of the operations in the exemplary flowcharts 300, 400, 500, and 600 may be eliminated or modified, without departing from the spirit and scope of the disclosure. Details described in all other embodiments of the subject application, e.g., in the embodiments of FIGS. 3-6, are applicable for this exemplary flowchart. Moreover, details described in this exemplary flowchart are applicable for all the embodiments of FIGS. 1, 2, and 7-11.

FIG. 7 illustrates a flow chart of an exemplary procedure of wireless communications in accordance with some embodiments of the present application. In the embodiments of FIG. 7, when one trigger condition generated or configured by a source RAT (e.g., source BS 702) and another trigger condition generated or configured by a target RAT (e.g., target BS 703) are both fulfilled for the same inter-RAT HO procedure, a UE (e.g., UE 701) may generate two entries or variables or may store two reports separately. Each entry or variable or report may be used by the UE to store, log, record, or generate successful inter-RAT HO related information correspondingly. Each entry or variable or report may be associated with one trigger condition, and each entry or variable or report is encoded based on the RAT type of the node which generates or configures the corresponding trigger condition.

For instance, when one trigger condition generated or configured by the source RAT is fulfilled, the UE may generate an entry or variable or a report or corresponding successful inter-RAT HO related information which is encoded in source RAT format (i.e., encoded in a RAT format of a source network node). The detailed contents in entry or variable or report or corresponding successful inter-RAT HO related information report can refer to above mentioned “the first information”. The UE may also store or log cell information associated with the source cell, e.g., CGI-Info-Logging of source cell which includes at least one of: a public land mobile network (PLMN) identity (ID), a cell ID, a tracking area code, a physical cell identifier (PCI), or an absolute radio frequency channel number (ARFCN). Optionally, the source cell C-RNTI encoded in the source RAT format is also included in the corresponding entry or variable or report (e.g., source cell C-RNTI is used by the source RAT to identify the UE and related information especially when the UE's context is released in the source RAT).

When one trigger condition generated or configured by the target RAT is met, the UE may generate an entry or variable or a report or corresponding successful inter-RAT HO related information which is encoded in the target RAT format (i.e., encoded in a RAT format of the target network node). The detailed contents in entry or variable or report or corresponding successful inter-RAT HO related information report can refer to above mentioned “the first information”. The UE may also store or log cell information associated with the target cell, e.g., CGI-Info-Logging of target cell which includes at least one of: a public land mobile network (PLMN) identity (ID), a cell ID, a tracking area code, a physical cell identifier (PCI), or an absolute radio frequency channel number (ARFCN).

To enable the successful decoding and MRO purpose in a network side, when the UE reports corresponding successful inter-RAT HO related information which is encoded in the source RAT format to a receiving node (e.g., BS 704 which is the serving node for the UE after the successful inter-RAT HO procedure, BS704 may be the target network node or a third party network node), the UE also encodes the cell information associated with the source cell, e.g., CGI-Info-Logging of source cell in the format of the receiving node, and the UE reports the cell information associated with the source cell to the receiving node. Then, based on the cell information associated with the source cell, the corresponding successful inter-RAT HO related information encoded in the source RAT format can be transferred to the source RAT or a source network node for a MRO purpose by the receiving node, via a new Xn message or the existing Xn message (e.g., ACCESS AND MOBILITY INDICATION). Similarly, when the UE reports corresponding successful inter-RAT HO related information which is encoded in the target RAT format to the receiving node, the UE also encodes the cell information associated with the target cell, e.g., CGI-Info-Logging of target cell, in the format of the receiving node, and the UE reports the cell information associated with the target cell to the receiving node. Then, based on the cell information associated with the target cell, the corresponding successful inter-RAT HO related information encoded in the target RAT format can be transferred to the target RAT or a target network node for a MRO purpose by the receiving node, via a new Xn message or the existing Xn message (e.g., ACCESS AND MOBILITY INDICATION). In the application, the receiving node can also be called as the network node connected with the UE after completing the inter-RAT HO procedure, which may be the source network node (e.g., source BS) or the target network node (e.g., target BS) or a third party network node which is different from the source network node and the target network node.

For example, in some embodiments as shown in FIG. 7, configurations for storing, logging, recording, generating or reporting an inter-RAT SHR may be configured to UE 701, e.g., via the MobilityFromNRCommand message for inter-RAT handover from NR to E-UTRAN, or via the MobilityFromEUTRACommand message for inter-RAT handover from E-UTRAN to NR. In operation 711, UE 701 receives a command for inter-RAT handover from source BS 702. For instance, if source BS 702 is a gNB, the command is a MobilityFromNRCommand message. If source BS 702 is an eNB, the command is a Mobility FromEUTRACommand message.

In operation 712, in one inter-RAT HO procedure, if Condition 1 (e.g., the first threshold generated or configured by source BS 702) and Condition 3 (e.g., the third threshold generated or configured by target BS 703) are both configured and fulfilled, UE 701 may generate a variable, e.g., VarInterRATSuccessHO-Report1, when Condition 1 is met, and UE 701 may also generate another variable, e.g., VarInterRATSuccessHO-Report2, when Condition 3 is met.

In an embodiment, in VarInterRATSuccessHO-Report1 or InterRATSuccessHO-Report1, or successful inter-RAT HO related information in VarInterRATSuccessHO-Report1 or InterRATSuccessHO-Report1, information of a source cell of source BS 702 (e.g., including: PLMN-Identity, Cell Identity and TrackingAreaCode, or, PCI and ARFCN; and measurements results of the source cell of source BS 702 when inter-RAT HO is executed or completed), information of a target cell of target BS 703 (e.g., including: PLMN-Identity, Cell Identity and TrackingAreaCode, or, PCI and ARFCN; and measurements results of the target cell of target BS 703 when inter-RAT HO is executed or completed), interRATSHR-Cause (t310-cause or interRATt310-cause which is set to “true”) and C-RNTI of the target cell may be included. The VarInterRATSuccessHO-Report1 or InterRATSuccessHO-Report1, or the successful inter-RAT HO related information in VarInterRATSuccessHO-Report1 or InterRATSuccessHO-Report1 may be encoded in the source RAT format (i.e., encoded in a RAT format of the source network node), e.g., a format of source BS 702 (e.g., if source BS 702 is a NG-RAN node, VarInterRATSuccessHO-Report1 or InterRATSuccessHO-Report1 is encoded in the NR format; if source BS 702 is a E-UTRAN node, VarInterRATSuccessHO-Report1 or InterRATSuccessHO-Report1 is encoded in the LTE format). Optionally, C-RNTI of the source cell which is encoded in the source RAT format is included in the VarInterRATSuccessHO-Report1 or InterRATSuccessHO-Report1, e.g., C-RNTI of the source cell is used by source BS 702 to identify UE 701 and the related information (e.g., information in InterRATSuccessHO-Report 1), especially when UE 701's context is released in source BS 702.

In another embodiment, in VarInterRATSuccessHO-Report2 or InterRATSuccessHO-Report2, or successful inter-RAT HO related information in VarInterRATSuccessHO-Report2 or InterRATSuccessHO-Report2, information of a source cell of source BS 702 (e.g., PLMN-Identity, Cell Identity and TrackingAreaCode, or, PCI and ARFCN), information of a target cell of target BS 703 (e.g., PLMN-Identity, Cell Identity and TrackingAreaCode, or, PCI and ARFCN), interRATSHR-Cause (t304-cause or interRATt304-cause which is set to “true”), ra-InformationCommon and C-RNTI of the target cell may be included. The VarInterRATSuccessHO-Report2 or InterRATSuccessHO-Report2, or the successful inter-RAT HO related information in VarInterRATSuccessHO-Report2 or InterRATSuccessHO-Report2 may be encoded in the target RAT format (i.e., encoded in a RAT format of the target network node), e.g., a format of target BS 703 (e.g., if target BS 703 is a EUTRAN node, VarInterRATSuccessHO-Report2 or InterRATSuccessHO-Report2 is encoded in LTE format; if target BS 703 is a NG-RAN node, VarInterRATSuccessHO-Report2 or InterRATSuccessHO-Report2 is encoded in NR format).

“VarInterRATSuccessHO-Report2” or “InterRATSuccessHO-Report2” or “the successful inter-RAT HO related information in VarInterRATSuccessHO-Report2 or InterRATSuccessHO-Report2” encoded in LTE format means that “VarInterRATSuccessHO-Report2” or “InterRATSuccessHO-Report2” or “the successful inter-RAT HO related information in VarInterRATSuccessHO-Report2 or InterRATSuccessHO-Report2” is encoded based on 3GPP TS36.331. “VarInterRATSuccessHO-Report2” or “InterRATSuccessHO-Report2” or “the successful inter-RAT HO related information in VarInterRATSuccessHO-Report2 or InterRATSuccessHO-Report2” encoded in NR format means that “VarInterRATSuccessHO-Report2” or “InterRATSuccessHO-Report2” or “the successful inter-RAT HO related information in VarInterRATSuccessHO-Report2 or InterRATSuccessHO-Report2” is encoded based on 3GPP TS38.331.

In operation 713, if the node which is the serving node for the UE after the successful inter-RAT HO procedure requests successful inter-RAT HO related information or inter-RAT SHR is a eNB (e.g., which may be a third party network node or a target network node, e.g., BS 704), UE 701 may send {InterRATSuccessHO-Report1 encoded in the source RAT format (i.e., encoded in a RAT format of the source network node), cell information associated with the source cell (e.g., CGI-Info-Logging of source cell) which is encoded in LTE format} and {InterRATSuccessHO-Report2 encoded in the target RAT format (i.e., encoded in a RAT format of the target network node), cell information associated with the target cell (e.g., CGI-Info-Logging of target cell) which is encoded in LTE format} to the receiving node, i.e., BS 704. The cell information associated with the source cell encoded in LTE format means that the cell information associated with the source cell is encoded based on 3GPP TS36.331. The cell information associated with the target cell encoded in LTE format means that the cell information associated with the target cell is encoded based on 3GPP TS36.331. In some embodiments as shown in FIG. 7, the receiving node can also be called as the network node connected with the UE after completing the inter-RAT HO procedure, which may be the source network node (e.g. source BS) or the target network node (e.g. target BS) or a third party network node which is different from the source network node and the target network node.

In operation 713, if the node which is the serving node for the UE after the successful inter-RAT HO procedure requests successful inter-RAT HO related information or inter-RAT SHR is a gNB (e.g., which may be a third party network node, e.g., BS 704), UE 701 may send {InterRATSuccessHO-Report1 encoded in source RAT format (i.e., encoded in a RAT format of the source network node), cell information associated with the source cell (e.g., CGI-Info-Logging of source cell) which is encoded in NR format} and {InterRATSuccessHO-Report2 encoded in the target RAT format (i.e., encoded in a RAT format of the target network node), cell information associated with the target cell (e.g., CGI-Info-Logging of target cell) which is encoded in NR format} to the receiving node, i.e., BS 704.

The cell information associated with the source cell encoded in NR format means that the cell information associated with the source cell is encoded based on 3GPP TS38.331. The cell information associated with the target cell encoded in NR format means that the cell information associated with the target cell is encoded based on 3GPP TS38.331.

Before operation 713, UE 701 may send an indication to the BS 704 to indicate that UE 701 has stored or generated successful inter-RAT HO related information or UE 701 has at least one InterRATSuccessHO-Report, e.g., via an RRC setup complete message, or an RRC resume complete message, or an RRC reconfiguration complete message.

In operation 714, based on cell information associated with the source cell (e.g., CGI-Info-Logging of source cell), BS 704 may send the InterRATSuccessHO-Report1 to source BS 702. Then, source BS 702 may perform MRO analysis and optimization for inter-RAT HO related parameters.

In operation 715, based on cell information associated with the target cell (e.g., CGI-Info-Logging of the target cell), BS 704 may send the InterRATSuccessHO-Report2 to target BS 703. Then, target BS 703 may perform MRO analysis and optimization for inter-RAT HO related parameters.

FIG. 8 illustrates a further flow chart of an exemplary procedure of wireless communications in accordance with some embodiments of the present application.

In embodiments of FIG. 8, when one trigger condition generated or configured by a source RAT (e.g., source BS 802) and another trigger condition generated or configured by a target RAT (e.g., target BS 803) are both fulfilled for the same inter-RAT HO procedure, a UE (e.g., UE 801) may generate one entry (e.g., VarInterRATSuccessHO-Report) to store, log, record, or generate whole successful inter-RAT HO related information. The entry or corresponding successful inter-RAT HO related information or InterRATSuccessHO-Report is encoded in target RAT format (i.e., encoded in a RAT format of a target network node) or a format of a target RAT (e.g., target BS 803). The detailed contents in entry or variable or report or corresponding successful inter-RAT HO related information report can refer to above mentioned “the first information”. The UE may also store or log cell information associated with the target cell, e.g., CGI-Info-Logging of target cell which includes at least one of: a public land mobile network (PLMN) identity (ID), a cell ID, a tracking area code, a physical cell identifier (PCI), or an absolute radio frequency channel number (ARFCN).

To enable the successful decoding and MRO purpose in a network side, when the UE reports InterRATSuccessHO-Report or successful inter-RAT HO related information which is encoded in target RAT format to a receiving node (e.g., BS 804 which is the serving node for the UE after the successful inter-RAT HO procedure, BS804 may be the target network node or a third party network node), the UE also encodes the cell information associated with the target cell (e.g., CGI-Info-Logging of target cell) in the format of the receiving node, and the UE reports the cell information associated with the target cell to the receiving node. In the application, the receiving node can also be called as the network node connected with the UE after completing the inter-RAT HO procedure, which may be the source network node (e.g., source BS) or the target network node (e.g., target BS) or a third party network node which is different from the source network node and the target network node. Then, based on the cell information associated with the target cell, the InterRATSuccessHO-Report or successful inter-RAT HO related information encoded in target RAT format can be transferred to the target RAT (e.g., target BS 803) for a MRO purpose by the receiving node. When the target RAT detects that the inter-RAT SHR is triggered due to fulfillment of a trigger condition generated or configured by the target RAT, the target RAT performs MRO analysis and optimization for inter-RAT HO related parameters. When the target RAT detects that the inter-RAT SHR is triggered due to fulfillment of a trigger condition generated or configured by the source RAT (e.g., source BS 802):
(1) Option 1: the target RAT informs the source RAT that the inter-RAT SHR is triggered due to fulfillment of a trigger condition generated or configured by the source RAT, via a new Xn message or the existing Xn message (e.g., ACCESS AND MOBILITY INDICATION). An indication may be included in the Xn message to indicate that the inter-RAT SHR is triggered due to fulfillment of a trigger condition generated or configured by the source RAT, or unsuitable configuration in the source RAT, or a cause for the inter-RAT SHR (e.g., t310 related triggering condition for the inter-RAT SHR is fulfilled, or t312 related triggering condition for the inter-RAT SHR is fulfilled) may be included in the Xn message. Then, the source RAT performs MRO analysis and optimization for inter-RAT HO related parameters.
(2) Option 2: the target RAT encodes the information in InterRATSuccessHO-Report with the source RAT format (i.e., a RAT format of the source network node), and sends the InterRATSuccessHO-Report encoded in the source RAT format (i.e., encoded in a RAT format of the source network node) to the source RAT, via a new Xn message or the existing Xn message (e.g., ACCESS AND MOBILITY INDICATION). Optionally, the target RAT sends the source cell C-RNTI which is encoded in the source RAT format to the source RAT (i.e., encoded in a RAT format of the source network node, e.g., source C-RNTI is used by the source RAT to identify the UE and related information, e.g., information in InterRATSuccessHO-Report, especially when the UE's context is released in the source RAT). Then, the source RAT performs MRO analysis and optimization for inter-RAT HO related parameters.

For example, in some embodiments as shown in FIG. 8, configurations for storing, logging, recording, generating or reporting an inter-RAT SHR may be configured to UE 801, e.g., via the MobilityFromNRCommand message for inter-RAT handover from NR to E-UTRAN, or via the MobilityFromEUTRACommand message for inter-RAT handover from E-UTRAN to NR. In operation 811, UE 801 receives a command for inter-RAT handover from source BS 802. For instance, if source BS 802 is a gNB, the command is a MobilityFromNRCommand message. If source BS 802 is an eNB, the command is a MobilityFromEUTRACommand message.

In operation 812, in one inter-RAT HO procedure, if Condition 1 (e.g., the first threshold generated or configured by source BS 802) and Condition 3 (e.g., the third threshold generated or configured by target BS 803) are both configured and fulfilled, UE 801 generates a variable, e.g., VarInterRATSuccessHO-Report. In VarInterRATSuccessHO-Report or InterRATSuccessHO-Report, or successful inter-RAT HO related information in VarInterRATSuccessHO-Report or InterRATSuccessHO-Report, information of a source cell of source BS 802 (e.g., including: PLMN-Identity, Cell Identity and TrackingAreaCode, or, PCI and ARFCN; and measurements results of the source cell of source BS 802 when inter-RAT HO is executed or completed), information of a target cell of target BS 803 (e.g., including: PLMN-Identity, Cell Identity and TrackingAreaCode, or, PCI and ARFCN; and measurements results of the target cell of target BS 803 when inter-RAT HO is executed or completed), interRATSHR-Cause (t310-cause or interRATt310-cause which is set to “true”, and t304-cause or interRATt304-cause which is set to “true”), ra-InformationCommon and target cell C-RNTI may be included. The VarInterRATSuccessHO-Report or InterRATSuccessHO-Report, or the successful inter-RAT HO related information in VarInterRATSuccessHO-Report or InterRATSuccessHO-Report is encoded in a format of target BS 803 (e.g., if target BS 803 is a EUTRAN node, VarInterRATSuccessHO-Report or InterRATSuccessHO-Report is encoded in LTE format; if target BS 803 is a NG-RAN node, VarInterRATSuccessHO-Report or InterRATSuccessHO-Report is encoded in NR format).

“VarInterRATSuccessHO-Report” or “InterRATSuccessHO-Report” or “the successful inter-RAT HO related information in VarInterRATSuccessHO-Report or InterRATSuccessHO-Report” encoded in LTE format means that

“VarInterRATSuccessHO-Report” or “InterRATSuccessHO-Report” or “the successful inter-RAT HO related information in VarInterRATSuccessHO-Report or InterRATSuccessHO-Report” is encoded based on 3GPP TS36.331. “VarInterRATSuccessHO-Report” or “InterRATSuccessHO-Report” or “the successful inter-RAT HO related information in VarInterRATSuccessHO-Report or InterRATSuccessHO-Report” encoded in NR format means that

“VarInterRATSuccessHO-Report” or “InterRATSuccessHO-Report” or “the successful inter-RAT HO related information in VarInterRATSuccessHO-Report or InterRATSuccessHO-Report” is encoded based on 3GPP TS38.331.

Optionally, the source cell C-RNTI encoded in the format of target BS 803 (i.e., encoded in a RAT format of the target network node) is also included in the VarInterRATSuccessHO-Report or InterRATSuccessHO-Report, e.g., source cell C-RNTI is used by source BS 802 to identify UE 801 and related information (e.g., information in InterRATSuccessHO-Report), especially when UE 801's context is released in source BS 802.

In operation 813, if the node which is the serving node for the UE after the successful inter-RAT HO procedure request or receives successful inter-RAT HO related information or inter-RAT HO is an eNB (e.g., which may be a third party network node or the target network node, e.g., BS 804), UE 801 sends {InterRATSuccessHO-Report encoded in the format of target BS 803, cell information associated with the target cell (e.g., CGI-Info-Logging of target cell) which is encoded in LTE format} to the receiving node, i.e., BS 804. The cell information associated with the target cell encoded in LTE format means that the cell information associated with the target cell is encoded based on 3GPP TS36.331. In some embodiments as shown in FIG. 8, the receiving node can also be called as the network node connected with the UE after completing the inter-RAT HO procedure, which may be the source network node (e.g., source BS) or the target network node (e.g., target BS) or a third party network node which is different from the source network node and the target network node.

In operation 813, if the node which is the serving node for the UE after the successful inter-RAT HO procedure requests or receives successful inter-RAT HO related information or inter-RAT HO is a gNB (e.g., which may be a third party network node, e.g., BS 804), UE 801 sends {InterRATSuccessHO-Report encoded in target RAT format (i.e., encoded in a RAT format of the target network node), cell information associated with the target cell (e.g., CGI-Info-Logging of target cell) which is encoded in NR format} to the receiving node, i.e., BS 804. The cell information associated with the target cell encoded in NR format means that the cell information associated with the target cell is encoded based on 3GPP TS38.331.

Before operation 813, UE 801 may send an indication to the BS 804 to indicate that UE 801 has stored or generated successful inter-RAT HO related information or UE 801 has one InterRATSuccessHO-Report, e.g., via an RRC setup complete message, or an RRC resume complete message, or an RRC reconfiguration complete message.

Based on cell information associated with the target cell (e.g., CGI-Info-Logging of target cell), BS 804 may send the InterRATSuccessHO-Report to target BS 803. Then, target BS 803 decodes the InterRATSuccessHO-Report. In some embodiments, when target BS 803 detects near-failure inter-RAT successful HO is due to fulfillment of Condition 3, target BS 803 performs MRO analysis and optimization for inter-RAT HO related parameters. In some embodiments, when it detects near-failure inter-RAT successful HO is due to fulfillment of Condition 1:
(1) Option 1: in operation 815A, target BS 803 informs source BS 802 that inter-RAT SHR is triggered due to fulfillment of T310 related condition for triggering inter-RAT SHR, e.g., via a new Xn message or the existing Xn message (e.g., ACCESS AND MOBILITY INDICATION). An indication may be included in the Xn message to indicate that inter-RAT SHR is triggered due to fulfillment of T310 related condition for triggering inter-RAT SHR or unsuitable configuration in the source RAT. Then, source BS 802 may perform MRO analysis and optimization.
(2) Option 2: in operation 815B, target BS 803 encodes the information in InterRATSuccessHO-Report with source RAT format (i.e., encoded in a RAT format of the source network node) (e.g., NR format if the source BS 802 is a gNB); and in operation 816B, target BS 803 sends the InterRATSuccessHO-Report encoded in source RAT format to source BS 802. Optionally, the target RAT sends the source cell C-RNTI which is encoded in the source RAT format to the source RAT. Then, source BS 802 may perform MRO analysis and optimization.

FIG. 9 illustrates another flow chart of an exemplary procedure of wireless communications in accordance with some embodiments of the present application. In embodiments of FIG. 9, when one trigger condition generated/configured by source RAT (e.g., source BS 902) and another trigger condition generated or configured by target RAT (e.g., target BS 903) are both fulfilled for the same inter-RAT HO procedure, a UE (e.g., UE 901) generates one entry (e.g., VarInterRATSuccessHO-Report) to store, log, record, or generate whole successful inter-RAT HO related information. The entry or corresponding successful inter-RAT HO related information or InterRATSuccessHO-Report is encoded in source RAT format (i.e., encoded in a RAT format of the source network node) or a format of a source RAT (e.g., source BS 902). The detailed contents in entry or variable or report or corresponding successful inter-RAT HO related information report can refer to above mentioned “the first information”. The UE may also store or log cell information associated with the source cell (e.g., CGI-Info-Logging of source cell) which includes at least one of: a public land mobile network (PLMN) identity (ID), a cell ID, a tracking area code, a physical cell identifier (PCI), or an absolute radio frequency channel number (ARFCN). Optionally, the source cell C-RNTI encoded in source RAT format is also included in the VarInterRATSuccessHO-Report or InterRATSuccessHO-Report, e.g., source cell C-RNTI is used by the source RAT to identify the UE and related information (e.g., information in InterRATSuccessHO-Report), especially when the UE's context is released in the source RAT.

To enable the successful decoding and MRO purpose in a network side, when the UE reports InterRATSuccessHO-Report or successful inter-RAT HO related information which is encoded in source RAT format (i.e., encoded in a RAT format of the source network node) to a receiving node (e.g., BS 904 which is the serving node for the UE after the successful inter-RAT HO procedure, BS 904 may be the target network node or a third party network node), the UE also encodes the cell information associated with the source cell (e.g., CGI-Info-Logging of source cell) in the format of the receiving node, and the UE reports the cell information associated with the source cell to the receiving node. Then, based on the cell information associated with the source cell, the InterRATSuccessHO-Report or successful inter-RAT HO related information encoded in source RAT format can be transferred to the source RAT (e.g., source BS 902) for MRO by the receiving node. In some embodiments, when the source RAT detects that inter-RAT SHR is triggered due to fulfillment of a trigger condition generated or configured by the source RAT, the source RAT performs MRO analysis and optimization for inter-RAT HO related parameters. In some embodiments, when it detects that inter-RAT SHR is triggered due to fulfillment of a trigger condition generated or configured by a target RAT (e.g., target BS 903):
(1) Option I: the source RAT informs the target RAT that inter-RAT SHR is triggered due to fulfillment of a trigger condition generated or configured by the target RAT, via a new Xn message or the existing Xn message (e.g., ACCESS AND MOBILITY INDICATION). An indication may be included in the Xn message to indicate that inter-RAT SHR is triggered due to fulfillment of a trigger condition generated or configured by the target RAT, or unsuitable configuration in the target RAT, or cause for inter-RAT SHR (e.g., t304 related triggering condition for inter-RAT SHR is fulfilled) may be included in the Xn message. Then, the target RAT performs MRO analysis and optimization for inter-RAT HO related parameters.
(2) Option II: the source RAT encodes the information in InterRATSuccessHO-Report with target RAT format (i.e., encoded in a RAT format of the target network node), and sends the InterRATSuccessHO-Report encoded in target RAT format to the target RAT, via a new Xn message or the existing Xn message (e.g., ACCESS AND MOBILITY INDICATION). Then, the target RAT performs MRO analysis and optimization for inter-RAT HO related parameters.

For example, in some embodiments as shown in FIG. 9, configurations for storing, logging, recording, generating or reporting an inter-RAT SHR may be configured to UE 901, e.g., via the MobilityFromNRCommand message for inter-RAT handover from NR to E-UTRAN, or via the MobilityFromEUTRACommand message for inter-RAT handover from E-UTRAN to NR. In operation 911, UE 901 receives a command for inter-RAT handover from source BS 902. For instance, if source BS 902 is a gNB, the command is a MobilityFromNRCommand message. If source BS 902 is an eNB, the command is a MobilityFromEUTRACommand message.

In operation 912, in one inter-RAT HO procedure, if Condition 2 (e.g., the second threshold generated or configured by source BS 902) and Condition 3 (e.g., the third threshold generated or configured by target BS 903) are both configured and fulfilled, UE 901 generates a variable, e.g., VarInterRATSuccessHO-Report. In VarInterRATSuccessHO-Report or InterRATSuccessHO-Report, or successful inter-RAT HO related information in VarInterRATSuccessHO-Report or InterRATSuccessHO-Report, information of a source cell of source BS 902 (including: PLMN-Identity, Cell Identity and TrackingAreaCode, or, PCI and ARFCN; and measurements results of the source cell of source BS 902 when inter-RAT HO is executed or completed), information of a target cell of target BS 903 (e.g., including: PLMN-Identity, Cell Identity and TrackingAreaCode, or, PCI and ARFCN; and measurements results of the target cell of target BS 903 when inter-RAT HO is executed or completed), interRATSHR-Cause (t312-cause or interRATt312-cause which is set to “true”, and t304-cause which is set to “true”), ra-InformationCommon and target cell C-RNTI are included. The VarInterRATSuccessHO-Report or InterRATSuccessHO-Report, or the successful inter-RAT HO related information in VarInterRATSuccessHO-Report or InterRATSuccessHO-Report is encoded in a format of source BS 902 (e.g., if source RAT is a NG RAN node, VarInterRATSuccessHO-Report or InterRATSuccessHO-Report is encoded in NR format; if source RAT is a EUTRAN node, VarInterRATSuccessHO-Report or InterRATSuccessHO-Report is encoded in LTE format).

“VarInterRATSuccessHO-Report” or “InterRATSuccessHO-Report” or “the successful inter-RAT HO related information in VarInterRATSuccessHO-Report or InterRATSuccessHO-Report” encoded in NR format means that “VarInterRATSuccessHO-Report” or “InterRATSuccessHO-Report” or “the successful inter-RAT HO related information in VarInterRATSuccessHO-Report or InterRATSuccessHO-Report” is encoded based on 3GPP TS38.331. “VarInterRATSuccessHO-Report” or “InterRATSuccessHO-Report” or “the successful inter-RAT HO related information in VarInterRATSuccessHO-Report or InterRATSuccessHO-Report” encoded in LTE format means that “VarInterRATSuccessHO-Report” or “InterRATSuccessHO-Report” or “the successful inter-RAT HO related information in VarInterRATSuccessHO-Report or InterRATSuccessHO-Report” is encoded based on 3GPP TS36.331.

Optionally, the source cell C-RNTI encoded in the format of source BS 902 is in also included the VarInterRATSuccessHO-Report or InterRATSuccessHO-Report, e.g., source cell C-RNTI is used by the source RAT to identify UE 901 and related information (e.g., information in InterRATSuccessHO-Report), especially when UE 901's context is released in source BS 902.

In some embodiments, if the node which is the serving node for the UE after the successful inter-RAT HO procedure requests or receives inter-RAT HO is an eNB (e.g., which may be a third party network node or the target network node), UE 901 sends {InterRATSuccessHO-Report encoded in source RAT format (i.e., encoded in a RAT format of the source network node), cell information associated with the source cell (e.g., CGI-Info-Logging of source cell) which is encoded in LTE format} to the receiving node, e.g., BS 904. The cell information associated with the source cell encoded in LTE format means that the cell information associated with the source cell is encoded based on 3GPP TS36.331. In some embodiments as shown in FIG. 9, the receiving node can also be called as the network node connected with the UE after completing the inter-RAT HO procedure, which may be the source network node (e.g., source BS) or the target network node (e.g., target BS) or a third party network node which is different from the source network node and the target network node.

In some embodiments, if the node which is the serving node for the UE after the successful inter-RAT HO procedure requests or receives successful inter-RAT HO related information or inter-RAT HO is a gNB (e.g., which may be a third party network node), UE 901 sends {InterRATSuccessHO-Report encoded in source RAT format (i.e., encoded in a RAT format of the source network node), cell information associated with the source cell (e.g., CGI-Info-Logging of source cell) which is encoded in NR format} to the receiving node, e.g., BS 904. The cell information associated with the source cell encoded in NR format means that the cell information associated with the source cell is encoded based on 3GPP TS38.331.

Before operation 913, UE 901 may send an indication to the BS 904 to indicate that UE 901 has stored or generated successful inter-RAT HO related information or UE 901 has one InterRATSuccessHO-Report, e.g., via an RRC setup complete message, or an RRC resume complete message, or an RRC reconfiguration complete message.

Based on cell information associated with the source cell, e.g., CGI-Info-Logging of the source cell, BS 904 may send the InterRATSuccessHO-Report to source BS 902. Then, source BS 902 decodes the InterRATSuccessHO-Report. When source BS 902 detects near-failure inter-RAT successful HO is due to fulfillment of Condition 2, source BS 902 may perform MRO analysis and optimization for inter-RAT HO related parameters. When source BS 902 detects that a near-failure inter-RAT successful HO is due to fulfillment of Condition 3:
(1) Option I: in operation 915A, source BS 902 informs target BS 903 that inter-RAT SHR is triggered due to fulfillment of T304 related condition for triggering inter-RAT SHR, via a new Xn message or the existing Xn message (e.g., ACCESS AND MOBILITY INDICATION). An indication may be included in the Xn message to indicate that inter-RAT SHR is triggered due to fulfillment of T304 related condition for triggering inter-RAT SHR, or RACH problem in target BS 903, or there is a configuration problem in target BS 903 for configuring parameters associated with inter-RAT HO. Then, target BS 903 performs MRO analysis and optimization.
(2) Option II: in operation 915B, source BS 902 encodes the information in InterRATSuccessHO-Report with target RAT format (e.g., LTE format if the target BS 903 is an eNB); and in operation 916B, source BS 902 sends the InterRATSuccessHO-Report encoded in target RAT or LTE format to target BS 903. Then, target BS 903 performs MRO analysis and optimization.

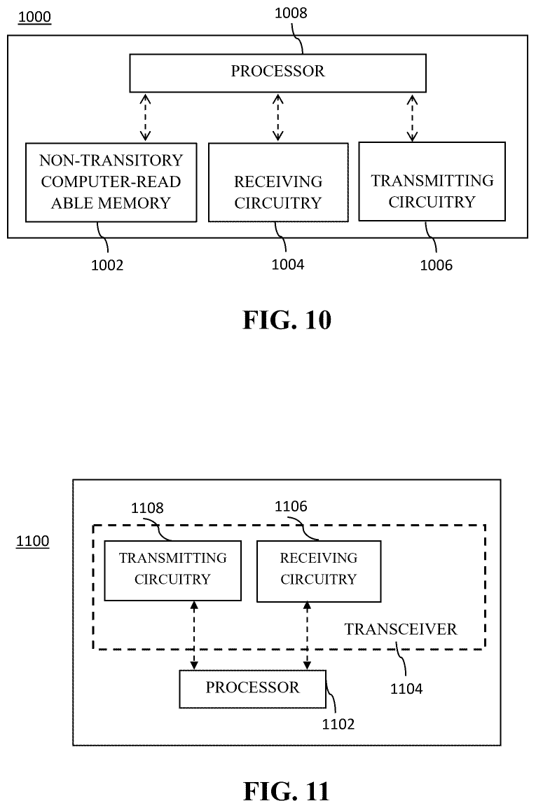

FIG. 10 illustrates an exemplary block diagram of an apparatus 1000 for an inter-RAT HO procedure in accordance with some embodiments of the present application. As shown in FIG. 10, the apparatus 1000 may include at least one non-transitory computer-readable medium 1002, at least one receiving circuitry 1004, at least one transmitting circuitry 1006, and at least one processor 1008 coupled to the non-transitory computer-readable medium 1002, the receiving circuitry 1004 and the transmitting circuitry 1006. The at least one processor 1008 may be a CPU, a DSP, a microprocessor etc. The apparatus 1000 may be a network node (e.g., a BS) or a UE configured to perform a method illustrated in the above or the like.

Although in this figure, elements such as the at least one processor 1008, receiving circuitry 1004, and transmitting circuitry 1006 are described in the singular, the plural is contemplated unless a limitation to the singular is explicitly stated. In some embodiments of the subject application, the receiving circuitry 1004 and the transmitting circuitry 1006 can be combined into a single device, such as a transceiver. In certain embodiments of the subject application, the apparatus 1000 may further include an input device, a memory, and/or other components.

In some embodiments of the subject application, the non-transitory computer-readable medium 1002 may have stored thereon computer-executable instructions to cause a processor to implement the methods with respect to a UE or a network node (e.g., a BS) as described or illustrated above. For example, the computer-executable instructions, when executed, cause the processor 1008 interacting with receiving circuitry 1004 and transmitting circuitry 1006, so as to perform the steps with respect to a UE or a network node (e.g., a BS) as described or illustrated above.

FIG. 11 illustrates a further exemplary block diagram of an apparatus 1100 for an inter-RAT HO procedure in accordance with some embodiments of the present application. Referring to FIG. 11, the apparatus 1100, for example a BS or a UE, may include at least one processor 1102 and at least one transceiver 1104 coupled to the at least one processor 1102. The transceiver 1104 may include at least one separate receiving circuitry 1106 and transmitting circuitry 1108, or at least one integrated receiving circuitry 1106 and transmitting circuitry 1108. The at least one processor 1102 may be a CPU, a DSP, a microprocessor etc.

According to some embodiments of the subject application, when the apparatus 1100 is a UE, the processor 1102 is configured to: receive a configuration regarding first information associated with a successful completion of an inter-radio access technology (RAT) handover (HO) procedure, wherein the configuration is related to at least one trigger condition for the UE storing the first information; and generate at least one report including the first information in response to fulfillment of the at least one trigger condition.

According to some other embodiments of the subject application, when the apparatus 1100 is a source network node (e.g., a source BS), the processor 1102 is configured to: generate a configuration regarding information associated with a successful completion of an inter-RAT HO procedure of a UE, wherein the configuration is related to at least one trigger condition for the UE storing the information; and transmit the configuration via the transceiver 1104 to the UE.

According to some other embodiments of the subject application, when the apparatus 1100 is a target network node (e.g., a target BS), the processor 1102 is configured to: generate a configuration regarding information associated with a successful completion of an inter-RAT HO procedure of a UE, wherein the configuration is related to at least one trigger condition for the UE storing the information; and transmit the configuration via the transceiver 1104 to a source network node.

According to some other embodiments of the subject application, when the apparatus 1100 is a network node (e.g., a BS), the processor 1102 is configured to: receive at least one report including information associated with a successful completion of an inter-RAT HO procedure via the transceiver 1104 from a UE, wherein the network node is connected with the UE after completing the inter-RAT HO procedure; and transfer the at least one report including the information via the transceiver 1104 to at least one of a source network node or a target network node.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the subject application, but is not used to limit the substance of the subject application.

1. A user equipment (UE) for wireless communication, comprising:
at least one memory; and
at least one processor coupled with the at least one memory and configured to cause the UE to:
receive a configuration regarding first information associated with a successful completion of an inter-radio access technology (RAT) handover (HO) procedure, wherein the configuration is related to at least one trigger condition for the UE storing the first information; and
generate at least one report including the first information in response to fulfillment of the at least one trigger condition.

2. The UE of claim 1, wherein the at least one trigger condition includes two or more trigger conditions, and wherein, to generate the at least one report in response to fulfillment of the two or more trigger conditions, the at least one processor is further configured to cause the UE to:
generate two or more reports including the first information; or
generate only one report including the first information.

3. The UE of claim 1, wherein each report within the at least one report or the first information includes at least one of:
information associated with a source cell of a source network node;
information associated with a target cell of a target network node;
a cell radio network temporary identifier (C-RNTI) of the source cell;
a C-RNTI of the target cell;
at least one cause associated with the at least one trigger condition; or
information associated with a radio access (RA) operation of the UE.

4. The UE of claim 2, wherein one report within the two or more reports is associated with one trigger condition within the two or more trigger conditions.

5. The UE of claim 4, wherein the at least one processor is further configured to cause the UE to encode the one report or the first information within the one report based on a RAT type of a network node, which generates the one trigger condition for the UE storing the first information within the one report.

6. The UE of claim 5, wherein the one report or the first information within the one report is encoded in:
a RAT format of a source network node; or
a RAT format of a target network node.

7. The UE of claim 4, wherein the at least one processor is further configured to cause the UE to:
generate second information associated with a cell of a first network node, wherein the first network node generates the one trigger condition for the UE storing the first information within the one report, and wherein the second information includes at least one of: a public land mobile network (PLMN) identity (ID), a cell ID, a tracking area code, a physical cell identifier (PCI), or an absolute radio frequency channel number (ARFCN); and
transmit the one report and the second information to a network node connected with the UE after completing the inter-RAT HO procedure.

8. The UE of claim 2, wherein the at least one processor is further configured to cause the UE to encode the only one report or the first information included in the only one report based on a RAT type of a target network node.

9. The UE of claim 8, wherein the at least one processor is further configured to cause the UE to:
generate cell information associated with a target cell of the target network node; and
transmit the only one report and the cell information via the transceiver-to a network node connected with the UE after completing the inter-RAT HO procedure, wherein the cell information includes at least one of: a public land mobile network (PLMN) identity (ID), a cell ID, a tracking area code, a physical cell identifier (PCI), or an absolute radio frequency channel number (ARFCN).

10. The UE of claim 2, wherein the at least one processor is further configured to cause the UE to encode the only one report or the first information included in the only one report based on a RAT type of a source network node.

11. The UE of claim 10, wherein the at least one processor is further configured to cause the UE to:
generate cell information associated with a source cell of the source network node, wherein the cell information includes at least one of: a public land mobile network (PLMN) identity (ID), a cell ID, a tracking area code, a physical cell identifier (PCI), or an absolute radio frequency channel number (ARFCN); and
transmit the only one report and the cell information to a network node connected with the UE after completing the inter-RAT HO procedure.

12. The UE of claim 6, wherein at least one of the RAT format of the source network node, the RAT format of the target network node, or the RAT format of the network node connected with the UE, is one of:
a format of a universal terrestrial radio access network (UTRAN);
a format of an evolved UTRAN (E-UTRAN);
a format of new radio (NR); and
a format of a next generation.

13. The UE of claim 1, wherein the at least one processor of the UE is further configured to cause the UE to:
transmit an indication for indicating generation of the at least one report via the transceiver to a network node connected with the UE after completing the inter-RAT HO procedure;
receive a request for the at least one report or the first information via the transceiver from the network node; and
transmit the at least one report via the transceiver to the network node.

14. A source network node for wireless communication, comprising:
at least one memory; and
at least one processor coupled with the at least one memory and configured to cause the source network node to:
generate a first configuration regarding first information associated with a successful completion of an inter-radio access technology (RAT) handover (HO) procedure of a user equipment (UE), wherein the first configuration is related to at least one trigger condition for the UE storing the first information; and
transmit the first configuration to the UE.

15. A target network node for wireless communication, comprising:
at least one memory; and
at least one processor coupled with the at least one memory and configured to cause the target network node to:
generate a second configuration regarding first information associated with a successful completion of an inter-radio access technology (RAT) handover (HO) procedure of a user equipment (UE), wherein the second configuration is related to at least one trigger condition for the UE storing the first information; and
transmit the second configuration via the transceiver to a source network node.

16. A processor for wireless communication, comprising:
at least one controller coupled with at least one memory and configured to cause the processor to:
receive a configuration regarding first information associated with a successful completion of an inter-radio access technology (RAT) handover (HO) procedure, wherein the configuration is related to at least one trigger condition for the processor storing the first information; and
generate at least one report including the first information in response to fulfillment of the at least one trigger condition.

17. The processor of claim 16, wherein the at least one trigger condition includes two or more trigger conditions, and wherein, to generate the at least one report in response to fulfillment of the two or more trigger conditions, the at least one controller is further configured to cause the processor to:
generate two or more reports including the first information; or
generate only one report including the first information.

18. The processor of claim 16, wherein each report within the at least one report or the first information includes at least one of:
information associated with a source cell of a source network node;
information associated with a target cell of a target network node;
a cell radio network temporary identifier (C-RNTI) of the source cell;
a C-RNTI of the target cell;
at least one cause associated with the at least one trigger condition; or
information associated with a radio access (RA) operation of the processor.

19. The processor of claim 17, wherein one report within the two or more reports is associated with one trigger condition within the two or more trigger conditions.

20. The processor of claim 19, wherein the at least one controller is further configured to cause the processor to encode the one report or the first information within the one report based on a RAT type of a network node, which generates the one trigger condition for the processor storing the first information within the one report.
